(19) United States
(12) Patent Application Publication
(10) Pub. No.: US 2016/0299657 A1
(43) Pub. Date: Oct. 13, 2016

(54) Gesture Controlled Display of Content Items

(71) Applicant: Apple Inc., Cupertino, CA (US)

(72) Inventors: Kyle Thomas Howarth, San Jose, CA (US); Martin J. Murrett, San Francisco, CA (US); Michel Elings, Palo Alto, CA (US); Robin Pieter van Dijke, San Jose, CA (US)

(21) Appl. No.: 14/932,815

(22) Filed: Nov. 4, 2015

Related U.S. Application Data
(60) Provisional application No. 62/146,160, filed on Apr. 10, 2015.

(51) Int. Cl. G06F 3/0488; G06F 3/0485; G06F 3/0482

(52) U.S. Cl. CPC G06F 3/0488; G06F 3/0482; G06F 3/0485

(57) ABSTRACT

The embodiments herein describe methods for displaying and navigating across content items in a content item list on a portable electronic device. For example, the embodiments herein describe a method for displaying a content item list adjacent to a content item view. The content list view includes a representation of the first content item and representations of previous and next content items. While the content list view is displayed, a movement of the touch input along the content list is detected, responsive to detection, the content item list is scrolled and a second content item is selected. The selected content item is displayed in the content item view adjacent to the content list view. An indication that the representation of a second content item in the content list view is currently selected is displayed.

### RELATED APPLICATIONS

This application claims the benefit of U.S. Provisional Patent Application No. 62/146,160, filed on Apr. 10, 2015, which is incorporated by reference in its entirety.

### TECHNICAL FIELD

This disclosure relates generally to gestures based access to content items on electronic devices with touch-sensitive surfaces.

### BACKGROUND

A touch-enabled electronic device typically has a touch sensitive surface, such as a touchscreen or touch pad. On such devices, gestures are the primary way that users enter commands and data, and manipulate content items presented in various applications. Applications generally provide access to content items through two user interface mechanisms. First, an application typically displays a list of available content items. The list is displayed in a predominant portion of the user interface, and the user traverses through the list to identify and select a content item of interest. In the list view, each content item is represented by a description, icon, thumbnail image, or some other view with reduced or limited information about the content item. Second, an application typically provides a content item view, in which a content item selected from a list can be viewed in detail, and in some cases edited.

For example, an email application on a handheld, touch-enabled device typically provides a content item list view in the form of a list of email messages in an inbox. The inbox is typically displayed over the full screen of the device. A user can traverse through the inbox to select a message to read. The email application then displays the selected message in an email reader or editor, which serves as a content view, and replaces the list view, and likewise covers the full screen. Other examples of applications that use a content list/content viewer model include photo viewers/editors, music players, document editors, account managers, commerce/shopping applications, and so forth.

In most applications, the content view provides access to next and previous items in the content list via graphical control buttons or icons. For example, an email application may include in the editor view a button to view the next email item in the inbox and a separate button to view the previous email item in the inbox. When selected, the application removes the current item and displays the next or previous item.

This methodology has the drawback that the user can only access the immediate next or previous items in the content item list, and is unable to arbitrarily access other items without dismissing the content item view and returning to the content list view. In addition, depending on the location of the next and previous buttons on the screen, and the size of the display, the user may not be able to reach the next/previous buttons with just one hand.

### SUMMARY

The embodiments herein describe methods for displaying and navigating across content items in a content item list on a portable electronic device.

In some embodiments, a computer-implemented method comprises displaying a first content item in a content item view on a touch screen display. While the first content item is displayed, a first touch input is detected that corresponds to a request to display a content list view. The first touch input may be for example, a navigation gesture starting at a first location on the display, and moving with a substantially linear, continuous, uninterrupted manner towards a second location on the display. Responsive to detecting the first touch input, the display of the content item view is shifted laterally, to provide an area adjacent the content view and between the content view and the vertical edge of the display. A content list view is displayed in this adjacent area, concurrently with the remaining portion of the content item view. The content list view includes a representation of the first content item and representations of previous content items and next content items. A representation is a short description, icon, thumbnail image, or other presentation of the content item that conveys identifying information for the content item without displaying the entire data of the content item.

While the content list view is displayed, a movement of the touch input along the content list is detected. The touch input is initiated at a first position, and the movement of touch input may pause for a predetermined amount of time at a second position in the content list. This pause is detected and an offset of the second position is determined with respect to the first position. The offset may be the number of content items above or below an initial content item representation in the content item list, a distance in pixels, or some other measure. Responsive to detecting the offset of the second position in the content list view, the content item list is scrolled.

In some embodiments, a boundary is displayed between a representation of the first content item and a representation of the second content item in the content item list view. The touch input reaching the boundary between the representation of the first content item and the second content item is detected. Responsive to this detection of touch input, in accordance with a determination that the touch input reaches a representation of a second content item in the content item list, an indication that the representation of the second content item is currently selected is displayed. This indication may be a highlighting, change in border, shadow, color, texture, font or other visual attribute of the second content item.

Along with the indication that the second content item is currently selected, a portion of the second content item may be concurrently displayed in the content item view during the movement of the touch input. While the portion of the second content items is thus displayed, a completion of the touch input is detected. The completion of touch input maybe, for example, lifting the finger off the display screen at some location between the two opposing edges of the screen. Responsive to the completion of the touch input the second content item is displayed in the content item view.

Furthermore, some embodiments herein describe a computer-implemented method comprising of displaying a first content in a content item view on a touch screen display. While the first content item is displayed, a touch input that corresponds to a request to display a content list view is detected. The first touch input may be for example, a navigation gesture starting at a first location on a display, for example a vertical edge of the display, and moving towards a second location for example an opposing vertical edge. Responsive to detecting the first touch input, the display of the content item view is shifted laterally, to provide an area adjacent to the content item view and between the content view and the vertical edge of the display. A content list view is displayed in this adjacent area, concurrently with the remaining portion of the content item view being displayed. The content list view includes a representation of the first content item and representations of previous and next content items. A midpoint is determined in the content item list and a position of a touch input is aligned with this midpoint. The representation of the first content item is then displayed at a position of the touch input, and the previous and next content items are displayed above and below the first content item.

In some embodiments, a movement of the touch input on the content list view is detected while the content list is being displayed. The touch input maybe, for example, a movement of sliding the finger or thumb up and down the content list. Responsive to detecting the movement of the touch input, in a content list view, the content list is scrolled synchronously with the movement of the touch input, while the representation of the first content item at the position of the touch input is maintained. During the movement of the touch input, as the content list view is scrolled, successive second ones of the next (or previous) content items in the content list view are displayed in the content item view. A completion of the touch movement is detected. The completion of the touch input maybe, for example, lifting off the finger or thumb at some location between the two opposing edges of the display. Responsive to the completion of the touch input, the second content item is displayed in the content item view. An indication that the representation of a second content item in the content list view is currently selected is displayed. This indication may be a highlighting, change in border, shadow, color, texture, font or other visual attribute of the second content item.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates an exemplary user interface of a content view of an email application in accordance with some embodiments.

FIG. 5B illustrates an edge-swipe gesture on the user interface of the content view of the email application to activate a content list view in accordance with some embodiments.

FIG. 5C illustrates an exemplary user interface of a portion of the content list view in response to an edge-swipe gesture and a content item view in accordance with some embodiments.

FIG. 5D illustrates an exemplary user interface of a portion of the content list view in response to continuation of the edge-swipe gesture and a content item view in accordance with some embodiments.

FIG. 5E illustrates an exemplary user interface of a content list view with a partial content item view in accordance with some embodiments.

FIG. 5F illustrates an exemplary user interface of a content list view and an indication of a content item that is currently selected is displayed in accordance with some embodiments.

FIG. 6 illustrates an exemplary user interface of a lift off gesture from the content list view in accordance with some embodiments.

FIG. 7 illustrates an exemplary user interface of an indication of a content item that is currently selected in the content list view and a representation of the content item in the content item view in accordance with some embodiments.

FIG. 8 illustrates an exemplary user interface of content item in a content item view, the content item selected by a user from a content list view in accordance with some embodiments.

FIG. 9A illustrates an exemplary user interface of representation of next item in the content list view and display of the next content item in the content item view in accordance with some embodiments.

FIG. 9B illustrates an exemplary user interface of representation of a second item in the content list view and display of the second item in the content item view in accordance with some embodiments.

FIG. 10A illustrates an exemplary user interface indicating synchronous scrolling of the content list view in the direction of the touch gesture in accordance with some embodiments.

FIG. 10B illustrates an exemplary user interface indicating synchronous scrolling of the content list and representation of the second content item in the content view in accordance with some embodiments.

FIG. 10C illustrates an exemplary user interface of lift off gesture from the touch point after scrolling the content list view in accordance with some embodiments.

FIG. 10D illustrates an exemplary user interface of a shifted content list view in accordance with some embodiments.

FIG. 10E illustrates an exemplary user interface of displaying the currently selected content item in the content item view in accordance with some embodiments.

FIG. 10F illustrates an exemplary user interface of an indication that the representation of a current content item in the content list is displayed in accordance with some embodiments.

FIG. 11A illustrates an exemplary user interface of a next content item in the content list view selected while the touch point is on the current item in the content list view in accordance with some embodiments.

FIG. 11B illustrates an exemplary user interface of a previous content item in the content list view selected while the touch point is on the current item in the content list view in accordance with some embodiments.

FIG. 12A illustrates an exemplary user interface of a continuous gesture component including horizontal and vertical movement components on a content item view in accordance with some embodiments.

FIG. 12B illustrates an exemplary user interface of a continuous gesture component including diagonal movement component on a content item view in accordance with some embodiments.

FIG. 12C illustrates an exemplary user interface of a previous content item in a content item view responsive to the continuous gesture component in accordance with some embodiments.

FIG. 12D illustrates an exemplary user interface of a continuous gesture component including horizontal and vertical movement components on a content item view in accordance with some embodiments.

FIG. 12E illustrates an exemplary user interface of a continuous gesture component including diagonal movement component on a content item view in accordance with some embodiments.

FIG. 12F illustrates an exemplary user interface of a next content item in a content item view responsive to the continuous gesture component in accordance with some embodiments.

FIG. 13A illustrates an exemplary user interface of a continuous gesture component including horizontal and vertical movement components on a content item view in accordance with some embodiments.

FIG. 13B illustrates an exemplary user interface of a previous content item in a content item view responsive to the continuous gesture component in accordance with some embodiments.

FIG. 13C illustrates an exemplary user interface of a continuous gesture component including horizontal and vertical movement components on a content item view in accordance with some embodiments.

FIG. 13D illustrates an exemplary user interface of a next content item in a content item view responsive to the continuous gesture component in accordance with some embodiments.

FIG. 14A illustrates exemplary user interface of a gesture including a start point of contact and the direction of the scroll to invoke a continuous scroll of the content item list in accordance with some embodiments.

FIG. 14B illustrates exemplary user interface of a gesture including a start point of contact and an end point of contact and the direction of the scroll to continue scrolling of the content item list in accordance with some embodiments.

FIG. 15 is a method flow diagram for displaying a content item in a content item view and displaying a content list view in response to a touch input in accordance with some embodiments.

FIG. 16 is a method flow diagram for displaying a second content item in the content item view by accessing the content item in the content list view in accordance with some embodiments.

FIG. 17 is a method flow diagram for displaying previous or next content items in response to a movement of the touch input in a content item view in accordance with some embodiments.

FIG. 18 is a method flow diagram for displaying previous or next content items in response to a movement of the touch input in accordance with some embodiments.

FIG. 19 is a method flow diagram for scrolling a content list to display that the representation of a content item in a content list is currently selected and displayed in a content item view in accordance with some embodiments.

FIG. 20 is a method flow diagram for displaying an indication that a representation of a second content item is selected at a position of a touch input in response to the touch input in accordance with some embodiments.

### DETAILED DESCRIPTION

In embodiments described below, methods for displaying and accessing content items in a list are achieved by providing a content list view within a content item view of an application. The content list view adjacent to the content item view enables a user to view and access arbitrary content items in the list. The content list view allows access to the arbitrary content items in the list with the use of one hand. This allows the user to efficiently view and access content items in a content item list in any application on a touch sensitive mobile device.

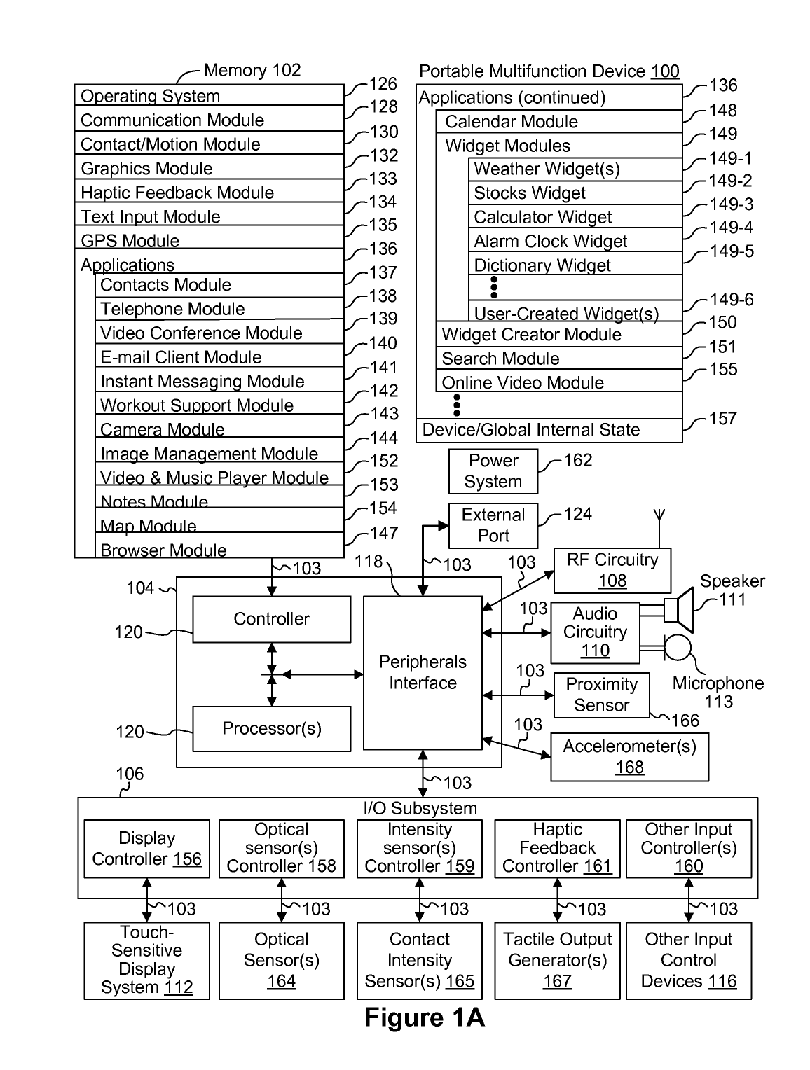

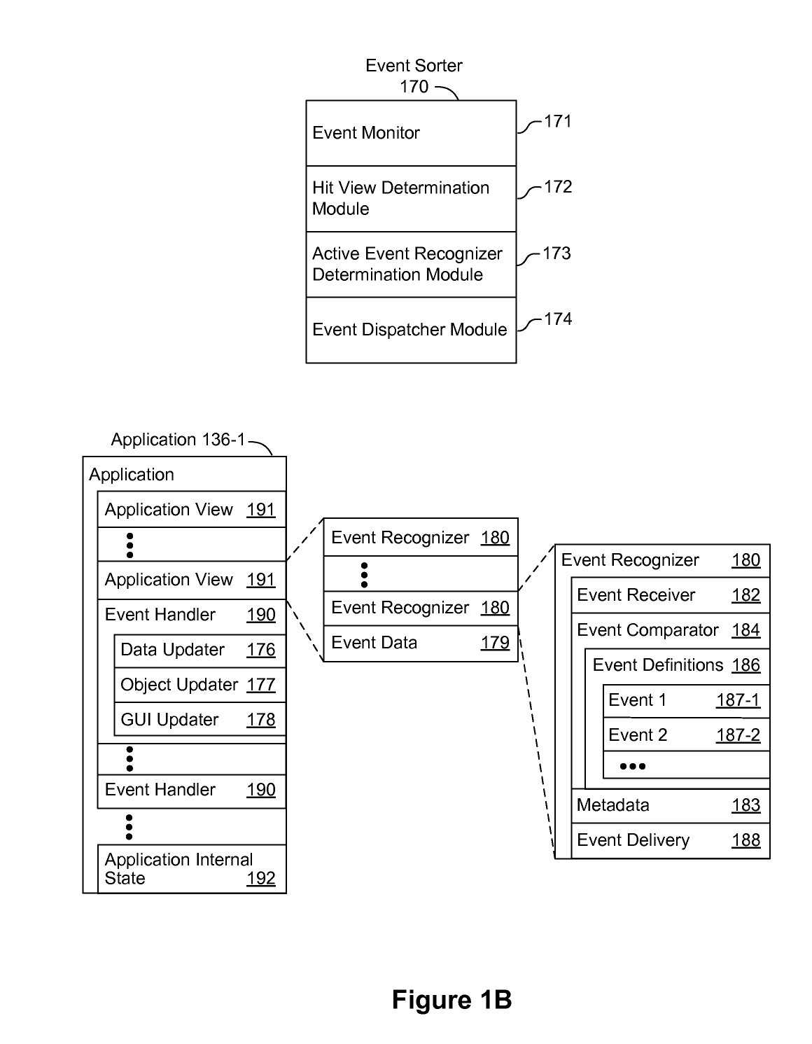

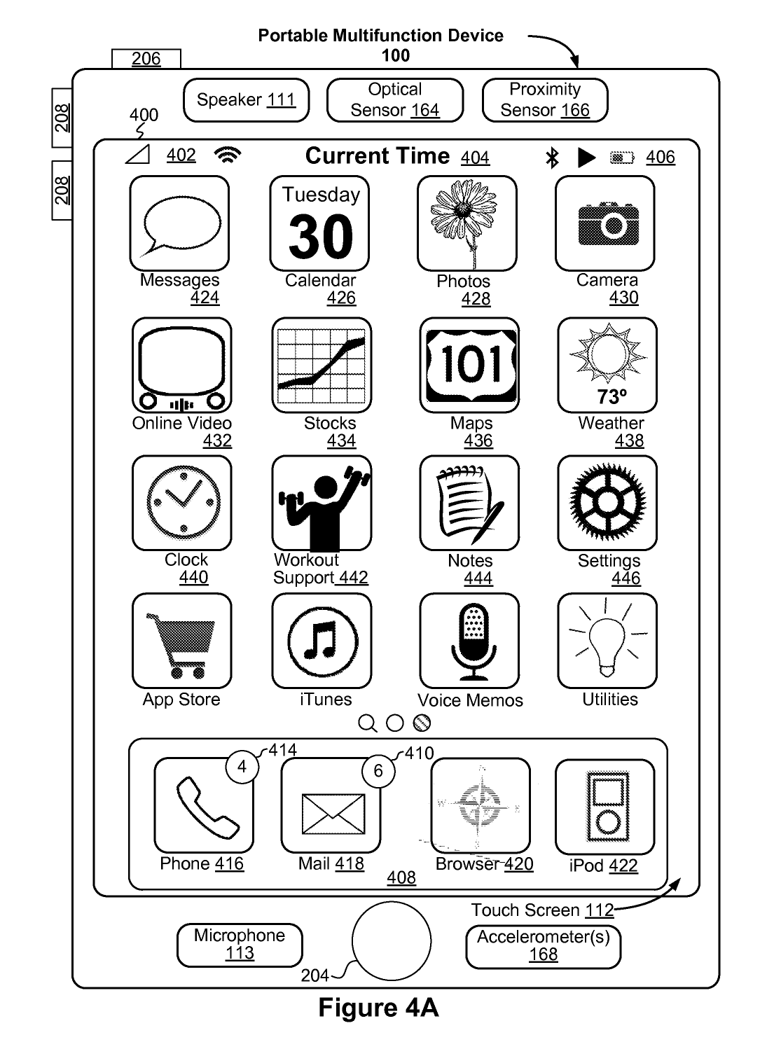

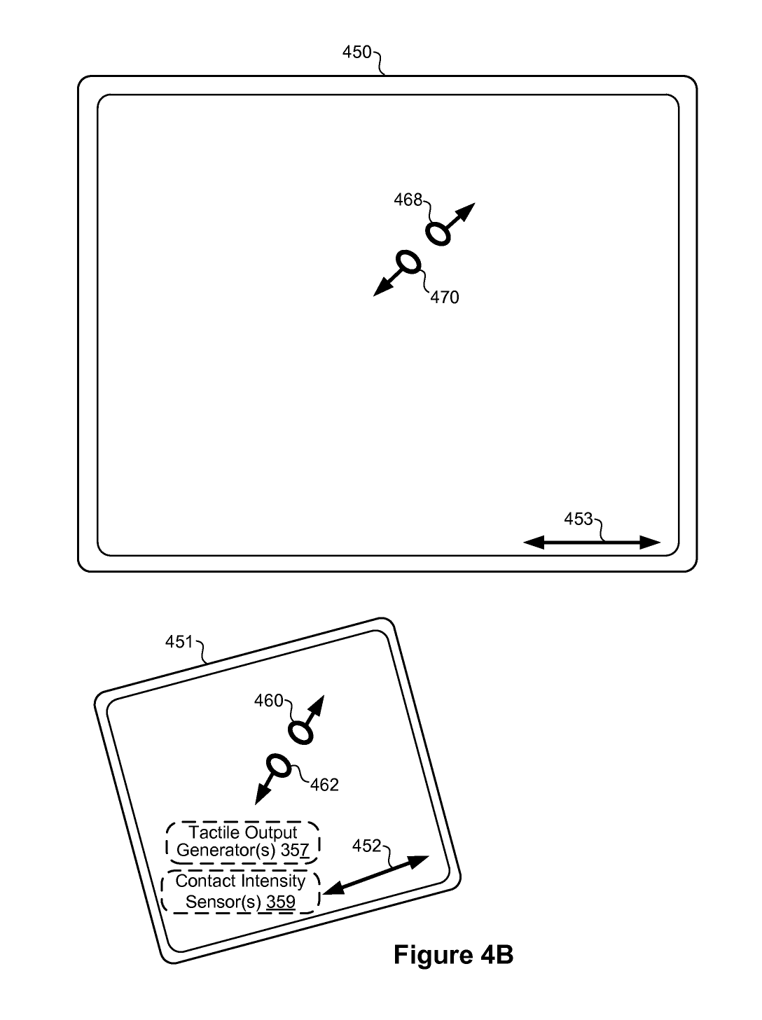

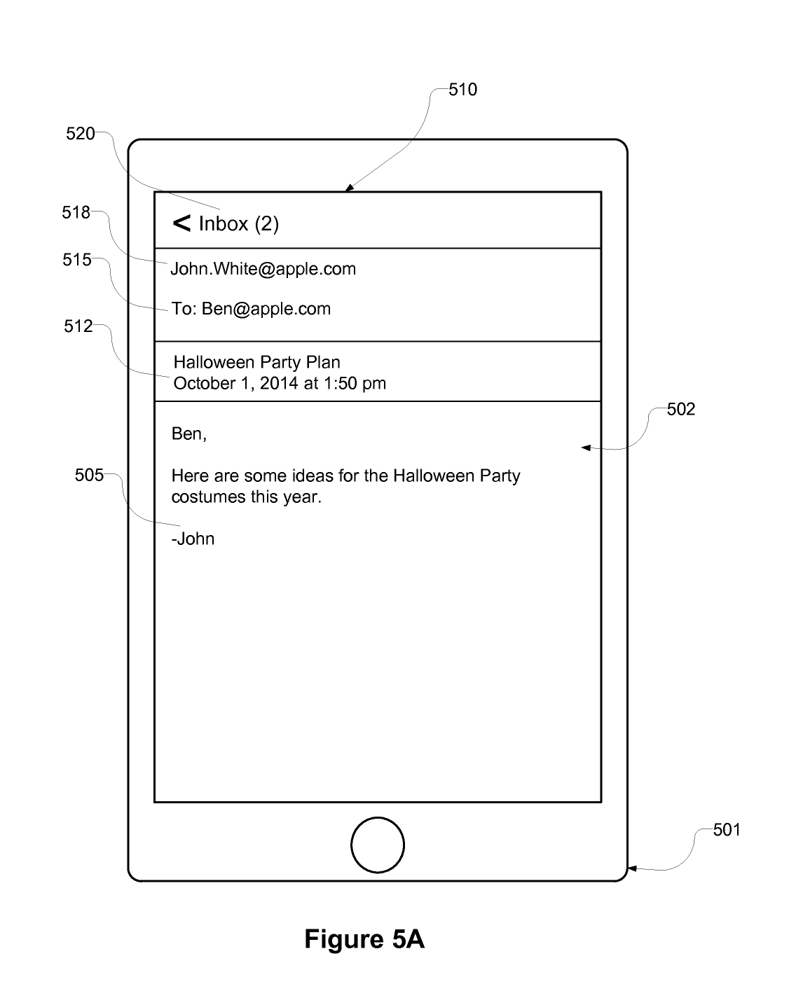

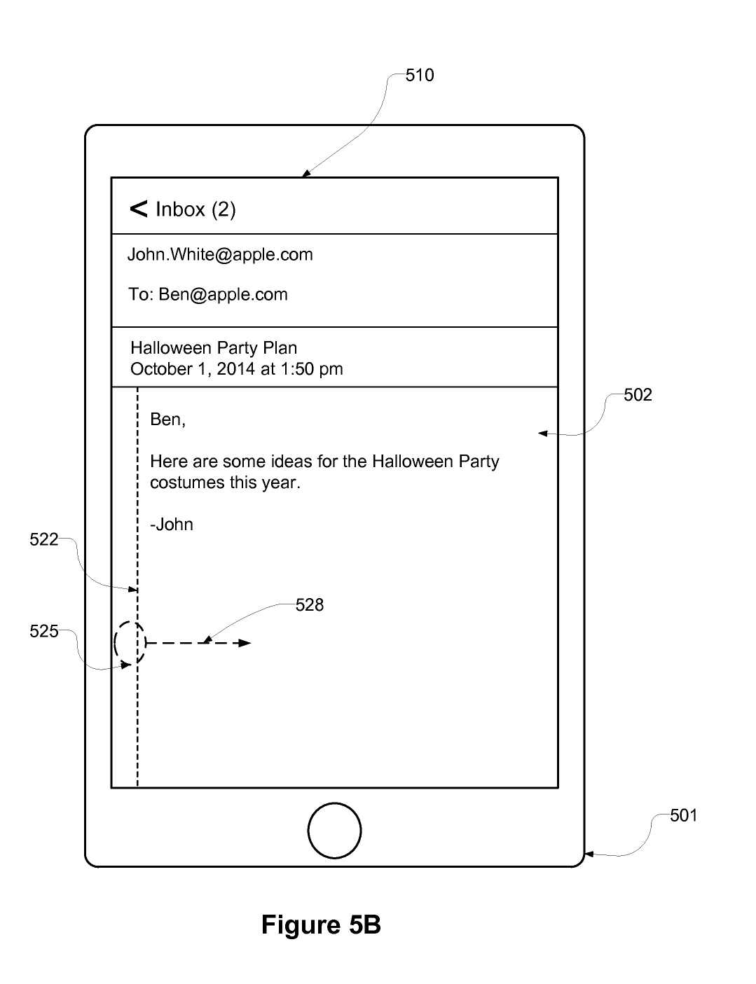

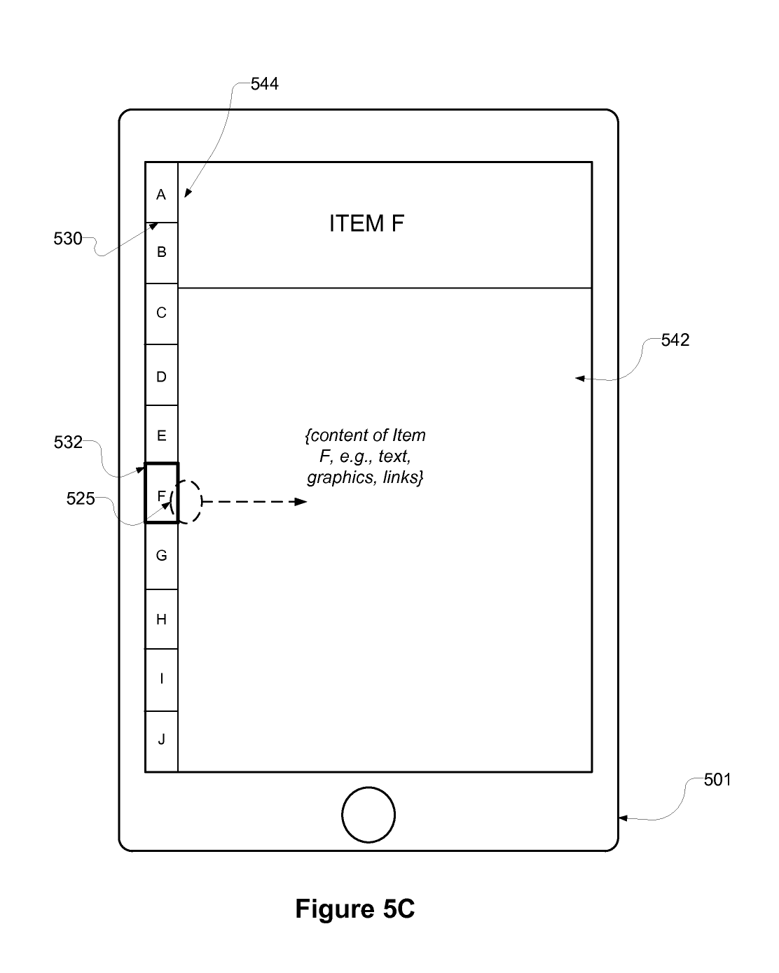

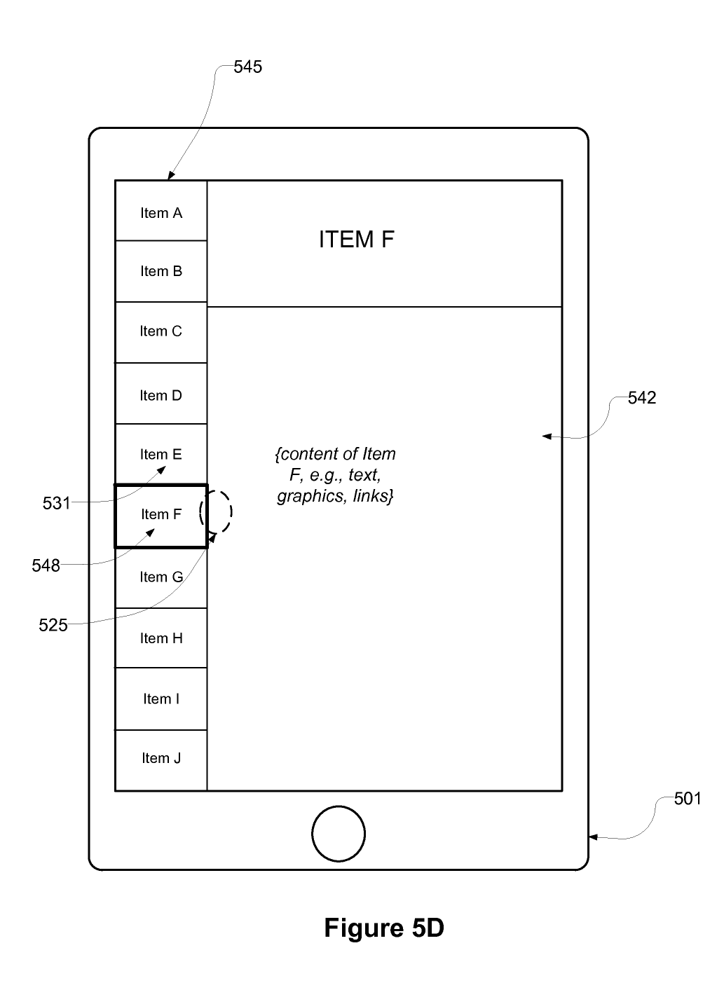

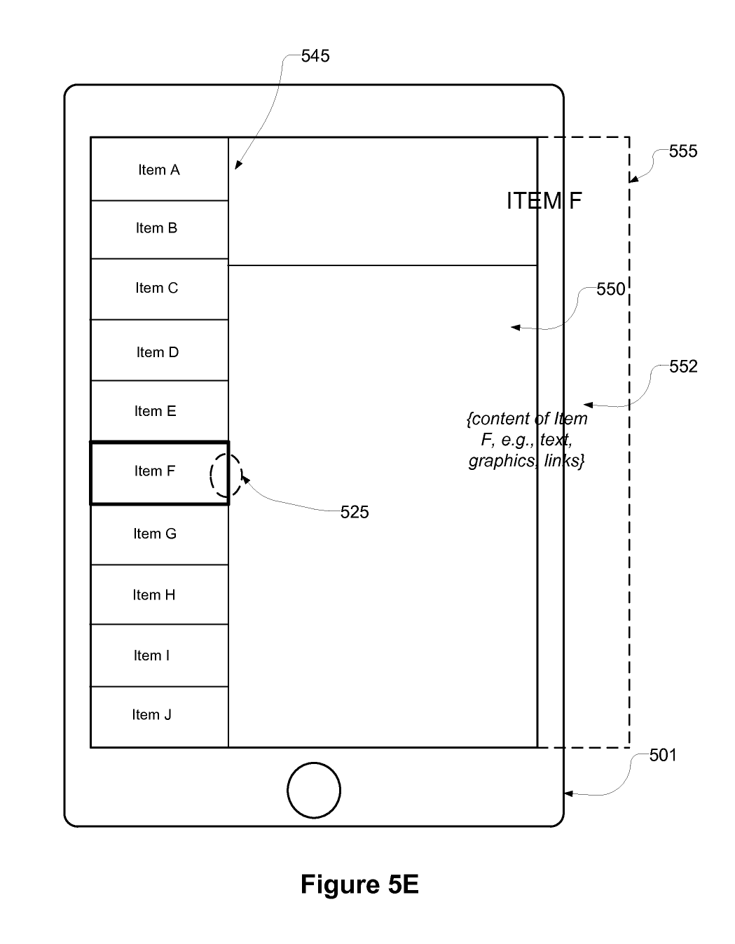

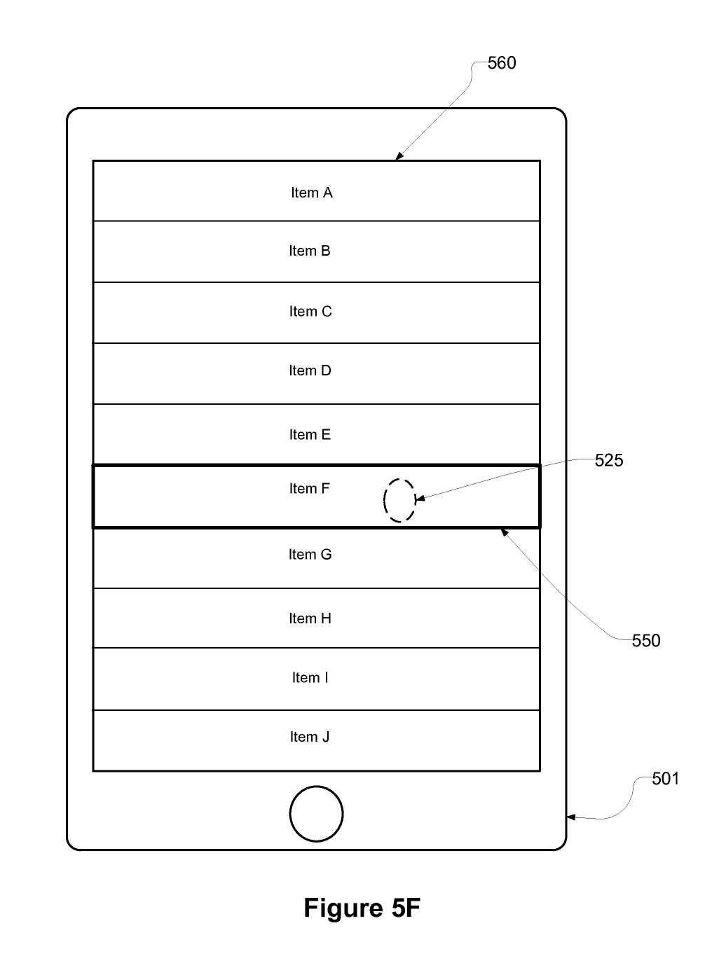

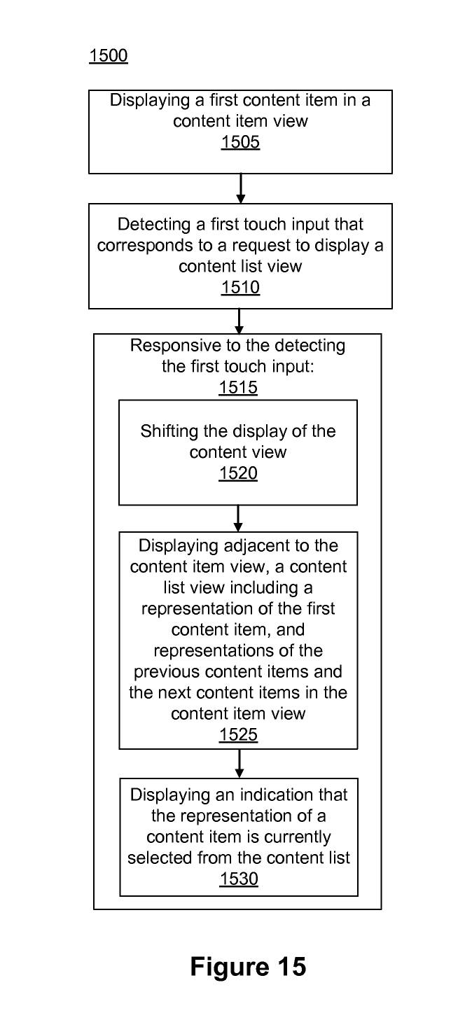

Below, FIGS. 1A-1B, 2, and 3 provide a description of exemplary devices. FIGS. 4A-4B illustrates exemplary user interfaces for the exemplary devices. FIGS. 5A-14B illustrates exemplary user interfaces for displaying various embodiments of a content list view with a content item view. FIGS. 15-20 illustrate flowchart methods for displaying and accessing content items in a content item view and a content list view in various embodiments.

### Exemplary Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU 120 and the peripherals interface 118, is, optionally, controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. However, in some embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11).

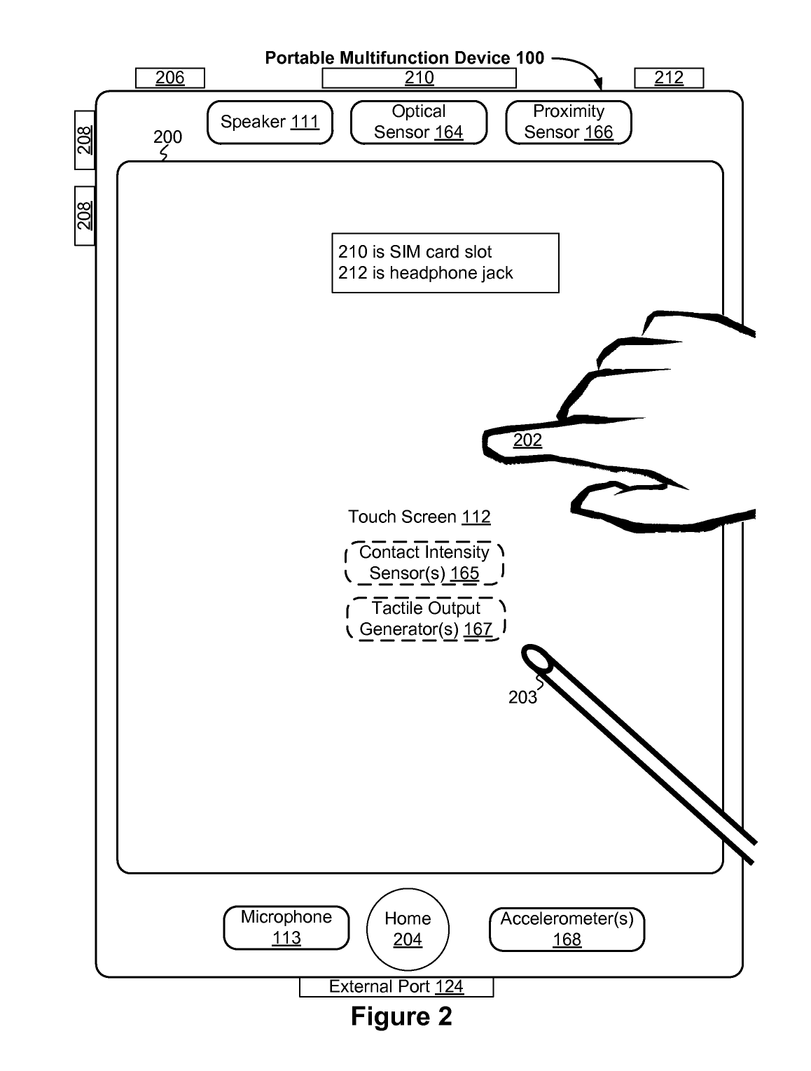

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in some embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device, so that the touch screen display is enabled for use as a viewfinder for still and/or video image acquisition. In some embodiments, another optical sensor is located on the front of the device so that the user's image is, optionally, obtained for videoconferencing while the user views the other video conference participants on the touch screen display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is coupled to input controller 160 in I/O subsystem 106. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

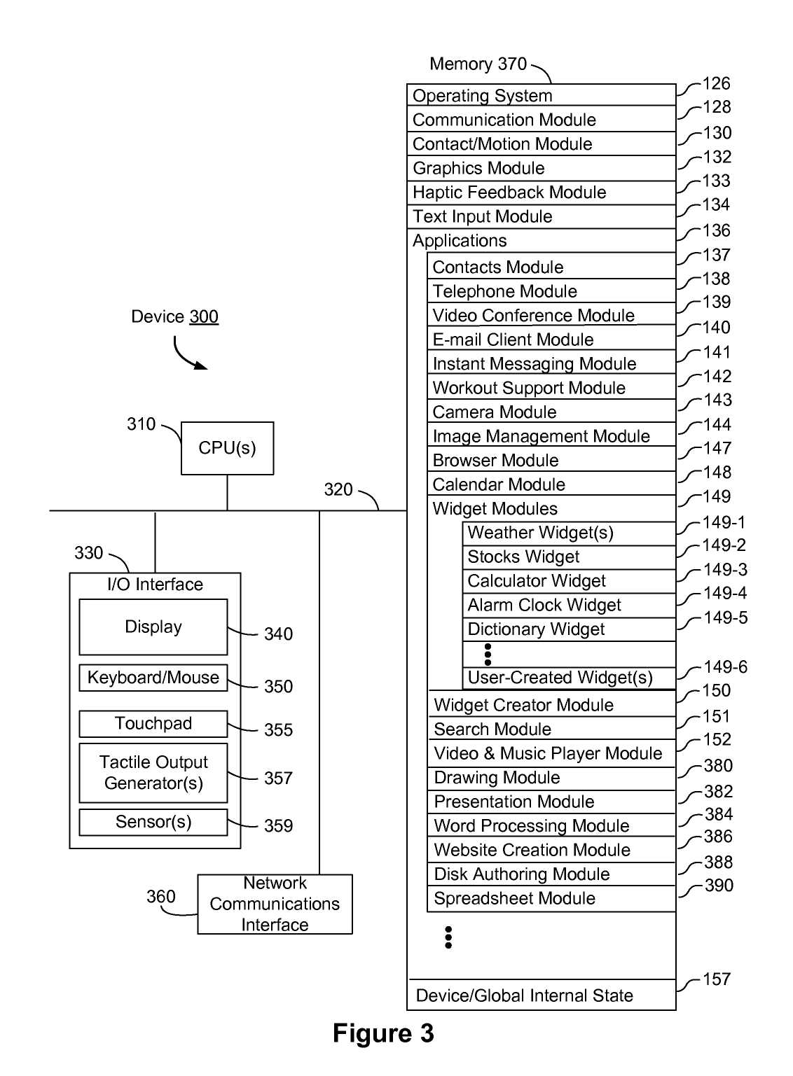

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined thresholds values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 are, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 are, optionally, used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 are, optionally, used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. However, in some embodiments, the menu button is a physical push button or other physical input control device instead of a touchpad.

FIG. 1 B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 137-13, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. However, in some embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. However some embodiments, active event recognizer determination module 173 determines that all views that include the physical location of a sub-event are actively involved views, and therefore determines that all actively involved views should receive a particular sequence of sub-events. In some embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. However, in yet some embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In some embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. However, in some embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, Subscriber Identity Module (SIM) card slot 210, head set jack 2 12, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that is, optionally, implemented on portable multifunction device 100.

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Text;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video”
   Icon 434 for stocks widget 149-2, labeled “Stocks;”
   Icon 436 for map module 154, labeled “Map;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, which provides access to
   settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Although some of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or touch screen 112 in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device with a display and a touch-sensitive surface, such as device 300 or portable multifunction device 100. Alternatively, the UIs and processes described herein could be implemented on any other device type.

FIG. 5A-5F illustrates exemplary user interfaces for displaying items in a content item view and a content list view adjacent to the content item view, in an example embodiment where the content items are emails. FIG. 5A illustrates a device 501 displaying a content item 505 from an email application 510 in an email content view 502. The email content view 502 includes a title element 520 indicating the currently selected folder to view the content items from. The email content view 502 includes a sender element 518 and a receiver element 515 along with the subject and date/time element 512. The email content view 502 includes a content matter element 505. The email content view 502 with the above mentioned elements is one example embodiment of a content item view.

In operation, a first touch input is detected on the content item view. In the figures, an initial point of contact for a touch input is illustrated by as open ellipse (e.g. touch input 525) and the movement of the contact along the surface of the display is shown as arrow (e.g. movement 528). Thus, FIG. 5B illustrates an example user interface for a first touch input 525 on the email content view 502 of a device 501. In some embodiments, the first touch input is a navigation gesture. A navigation gesture generally starts at a first location e.g. proximate to an edge 522 of the screen display and moves 528 with a substantially linear, continuous, uninterrupted manner towards a second location, for example, the opposing edge of the screen display in a continuous motion. The gesture need not reach the opposing edge. A navigation gesture is completed when the user lifts off their finger at some location on the display screen, the location being the second location, thereby breaking contact with the surface of the display. A navigation gesture can be either a horizontal navigation gesture, moving in a horizontal direction from a first location to a second location on the display screen, for example, the left edge towards the right edge or vice versa, in a single movement, or a vertical navigation gesture, moving in a vertical direction from a first location to a second location on the display screen, for example from the top edge towards a bottom edge or vice versa, in a single movement. The content item view is displayed along the first edge of the screen display. In the illustrated example, the first touch input is a horizontal navigation gesture initiated near the left edge of the display.

The first touch input corresponds to a request to display a content list view on the display screen. In response to the first touch input the content item view 502 is shifted on the display. FIG. 5C illustrates in schematic form a user interface of displaying a partial content list view 544 in response to the detection of the first touch input 525, after the content item view 502 has been shifted to the right. In this illustration the content item is schematically indicated as Item F. The partial content list view 544 is displayed adjacent to the content item view 542 in the direction of the navigation gesture. The partial content list view further includes a list of a plurality of content items, for example Item A through Item J seen partially in the FIG. 5C. The first content item is separated from the second content item by a representation of a boundary 530 between them. The representation that a content item is currently selected from the content item list is indicated, for example, by highlighting the boundary 532 of the currently selected content item in the content item list, or by other graphical indicia, for example by shading, color, texture, or text formatting, or other characteristics. The content item matter for the currently selected content item from the content item list is displayed in the adjacent content item view 542.

In accordance with continuation of the response of the first touch input, the content list view is further displayed to a full view. FIG. 5D illustrates in schematic form a user interface displaying a complete content list view 545 in continuation of the response of the first touch input 525. A representation 548 of each of content items in the content item list 545 can be viewed completely. The representation is a short description, icon, thumbnail image, or other presentation of the content item that conveys identifying information for the content item without displaying the entire data of the content item. The displaying of complete content list view indicates that the representation of the content item in the content item list can be entirely viewed. The content item that is currently selected is displayed in the adjacent content item view 542.

In accordance with continuation of the response of the first touch input, the content item view and the content list view is further shifted in the direction of the first touch input. FIG. 5E illustrates in schematic form a user interface displaying a partial content item view 550 with a portion 552 of the content item view shifted off screen with a full content list view 545 in continuation of the response of the first touch input. The content item view edge 555 indicates the extent of the portion 552 of the content item view that is shifted out of display of the screen in response to the first touch input 525. The portion 552 of the content item is no longer displayed on the display screen, but may be persistently held in memory for subsequent display. In some embodiments, the content item view 545 is shifted at a first rate/velocity (e.g. pixels per second) that is greater than a second rate/velocity of the first touch input 525; the first rate can be linearly proportional of the second rate (e.g., a multiple thereof), or non-linearly related (e.g., the first rate increase over the duration of the touch input, so that the shift appears to accelerate). Thus, in some embodiments, the shifting of the display of the content item view in response to the first touch input comprises of detecting a first amount (e.g. number of pixels) of movement of the touch input in a first direction. The first direction can be moving horizontally from the left edge of the screen to the right edge and vice versa. The content item view is shifted by the detected first amount of movement. A second amount of movement of the touch input is detected in the first direction and the content item view is shifted a multiple of the second amount of movement in the first direction. The content item view 550 moves synchronously with the movement of the first touch input 525. In some embodiments, the shifting of the display of the content item view comprises sliding a first portion 552 of the content item view off the screen. A second portion 550 of the content item view is displayed on the screen.

In some embodiments, responding to the movement of the first touch input, the content item view is completely shifted off the display screen and replaced by the content item list view. FIG. 5F illustrates in schematic form a user interface displaying a full content item list view 560 that replaces the content item view on the entirety of the display screen. The representation that a content item is currently selected from the content item list is indicated, for example, by highlighting the boundary 550 of the currently selected content item in the content item list, or by other graphical indicia, for example by shading, color, texture, or text formatting, or other characteristics. The first touch input 525 indicates a currently selected item in the content item list.

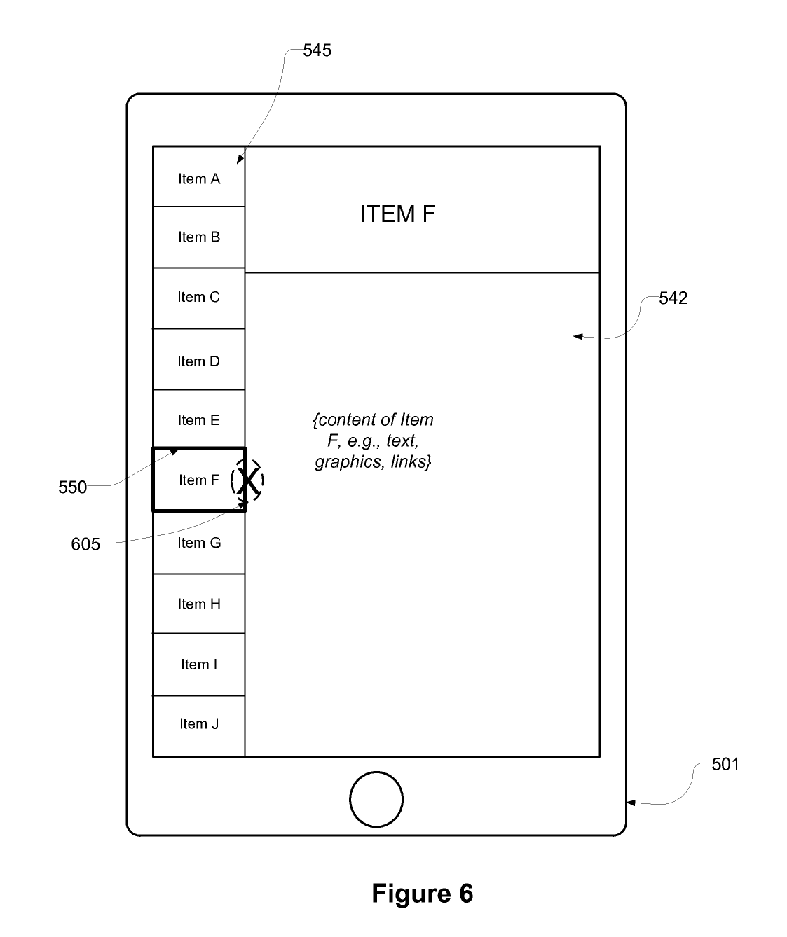

Next, in some embodiments, the completion of the movement of the touch input is detected. FIG. 6 illustrates in schematic form a user interface displaying the completion of the movement of the touch input 605, an example of the completion is a user lifting off the finger from the touch screen display. In the figures, the completion of a touch input 605 is illustrated by an ellipse with an “X” therein. In some embodiments, in response to the completion of the movement of the touch input, a content item that is currently selected is indicated by highlighting the boundary 550 of the current content item. The content item that is currently selected is displayed in the adjacent content item view 542.

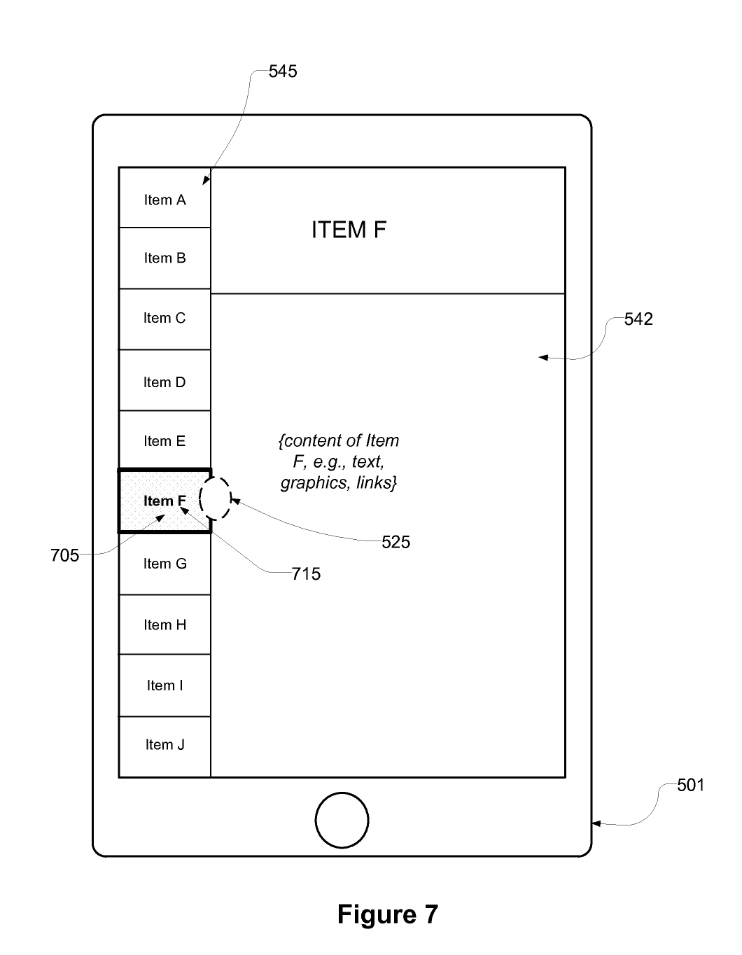

FIG. 7 illustrates in schematic form a user interface displaying an alternative indication of the currently selected content item in a content item list. In addition to highlighting the boundary of the currently selected content item, the representation of the content item is shaded 705 and highlighted 715. The currently selected content item is displayed in the adjacent content item view 542.

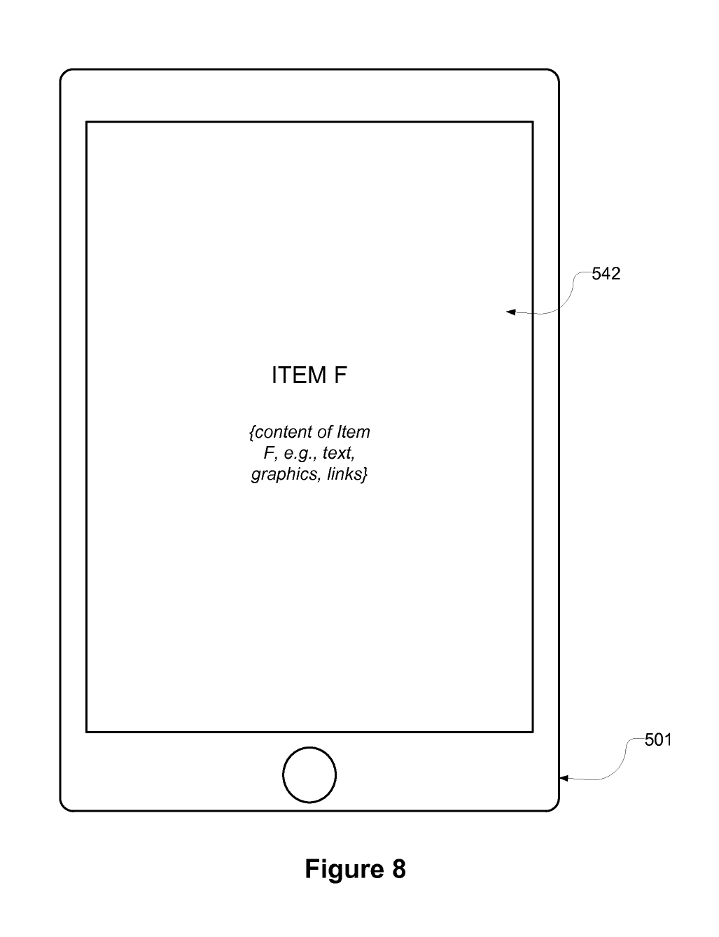

In some embodiments, in response to the completion of the movement of the touch input, the selected content item from the content list is displayed entirely in a content item view. FIG. 8 illustrates in schematic form a user interface displaying a content item from the content list entirely in a content item view 542. There content list adjacent to the content item view is removed from display.

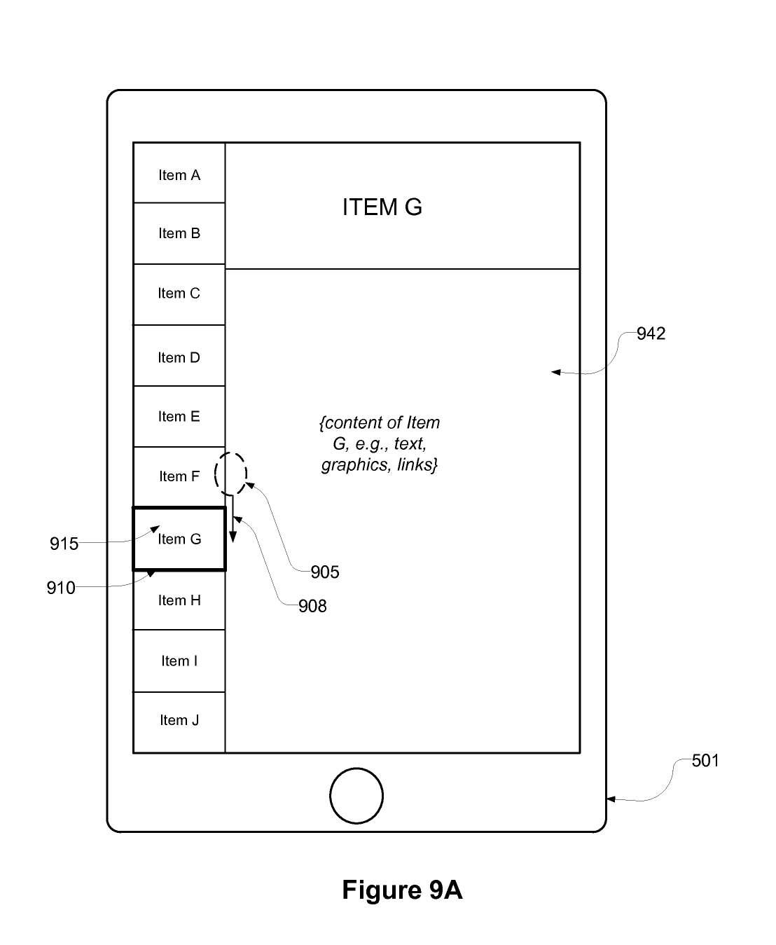

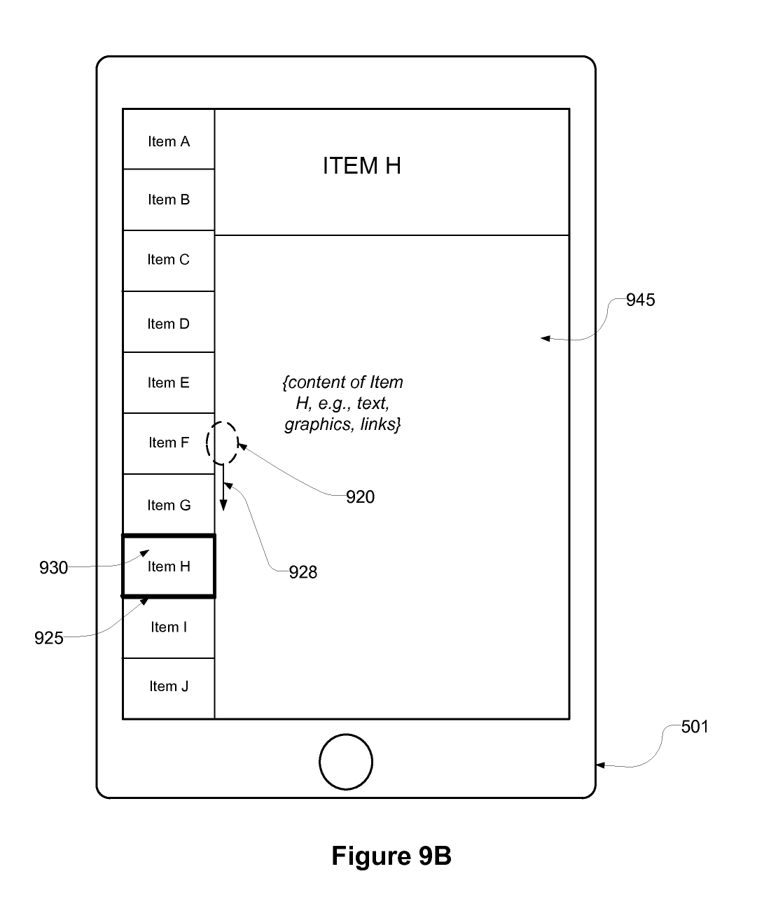

While the content list view is displayed, a movement of the touch input is detected along the content item list, for example in vertical direction where the content list view is arranged in a single vertical fashion. FIG. 9A-9B illustrate in schematic form a user interface displaying a second content item 915 (FIG. 9A) and 930 (FIG. 9B) from the content item list in response to the movement 908 (FIG. 9A) and 928 (FIG. 9B) of the touch input. The touch input is initiated in a first position 905 (FIG. 9A) and 920 (FIG. 9B), i.e. an initial point of contact. In some embodiments, the movement (FIG. 9A) and 928 (FIG. 9B) of the touch input 908 pausing for a predetermined amount of time, for example, 2 seconds, is detected. An offset of the second position is determined with respect to the first position of the touch input. In some embodiments, the offset is the number of content items above or below an initial content item representation in the content item list. In response to the offset of the second position of the point of contact, the content list is scrolled and the second content item is selected. The second content item can be any one of the next content item or previous content items in the content item list. The currently selected content item (e.g., Item H) is displayed in the content item view 942 (FIG. 9A) and 945 (FIG. 9B). The indication that a representation (e.g., 930) (FIG. 9B) of the second content item is selected is displayed by highlighting 910 (FIG. 9A) and 925 (FIG. 9B) the boundary of the second content item or by other graphical indicia, for example by shading, color, texture, or text formatting, or other characteristics.

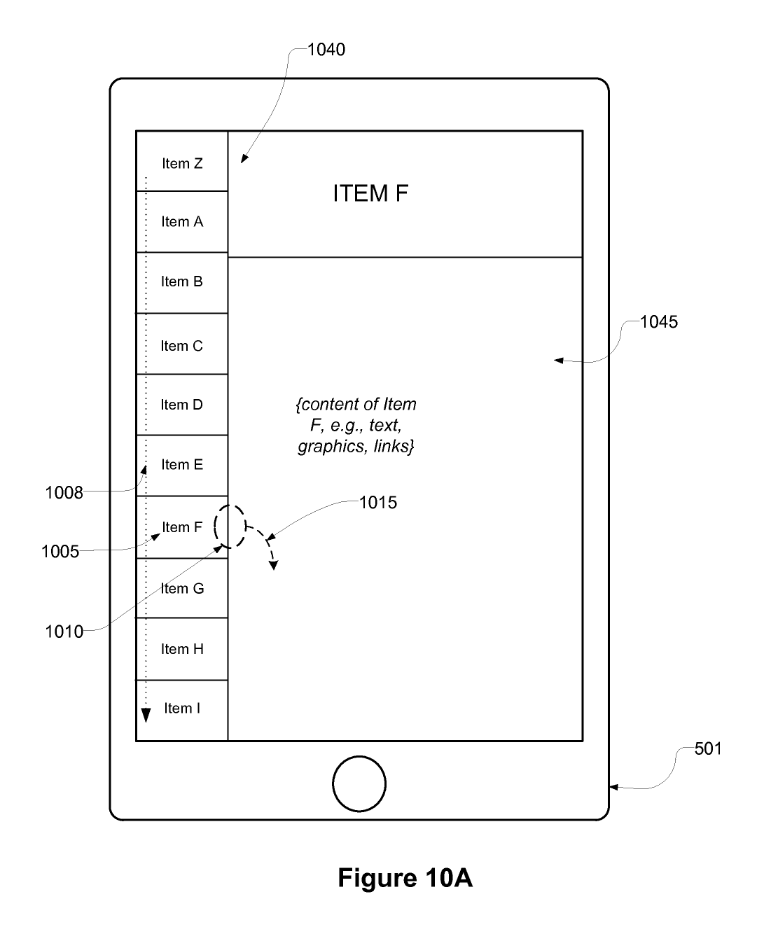

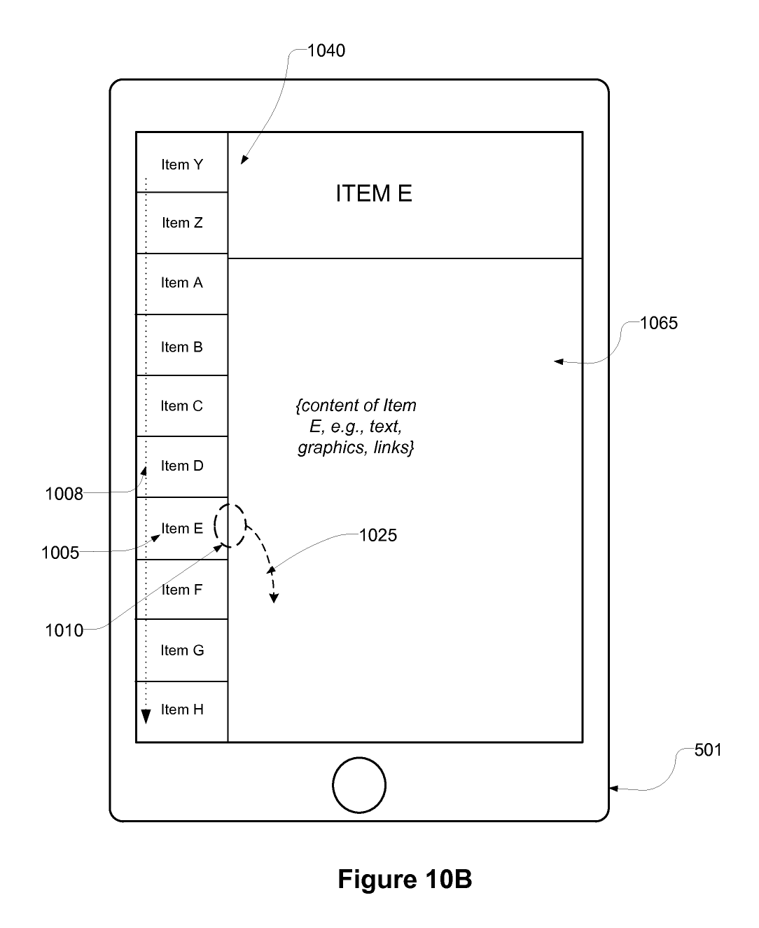

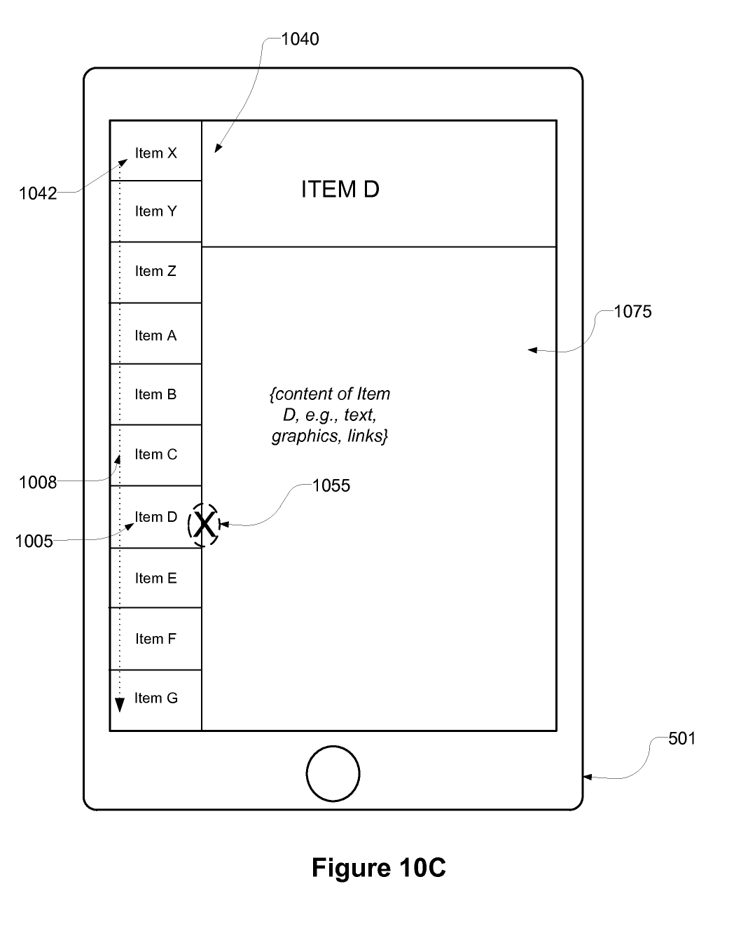

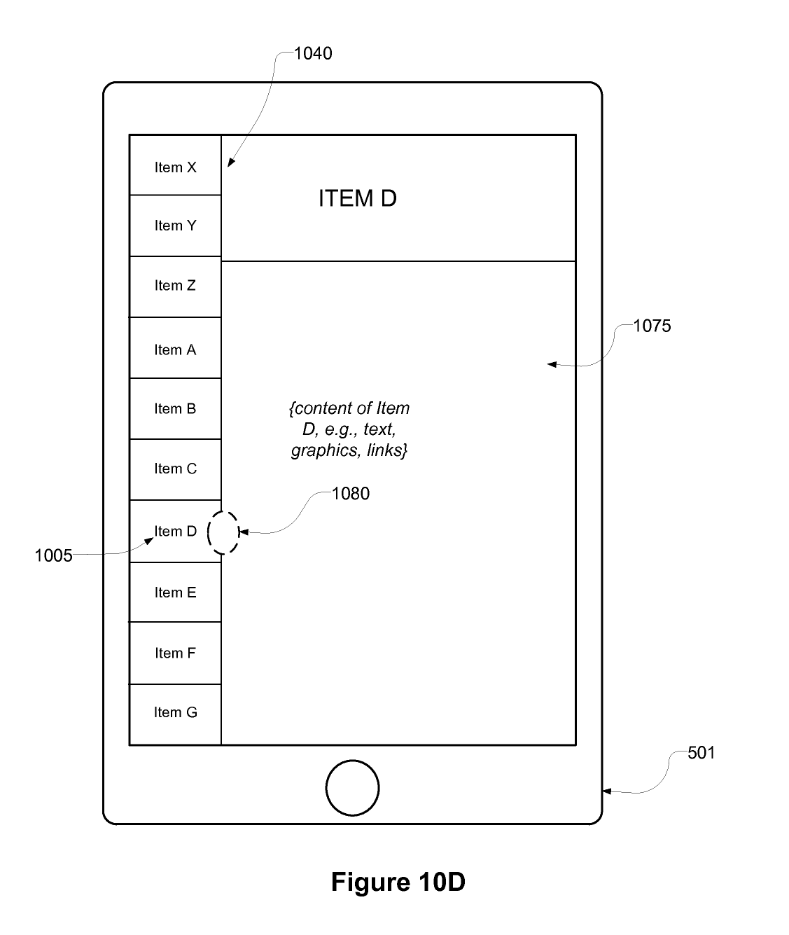

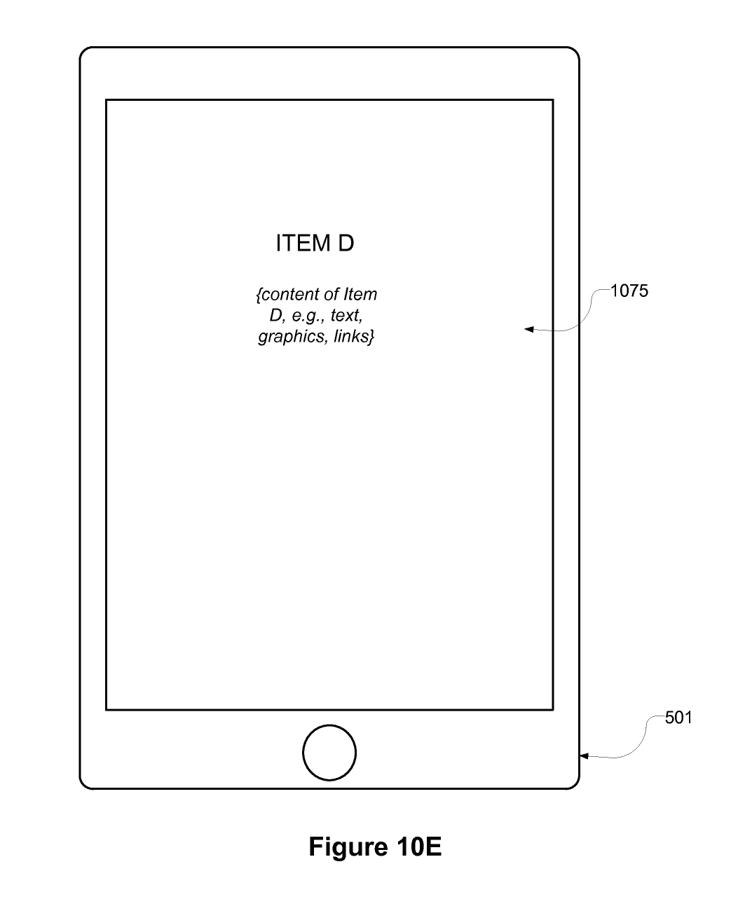

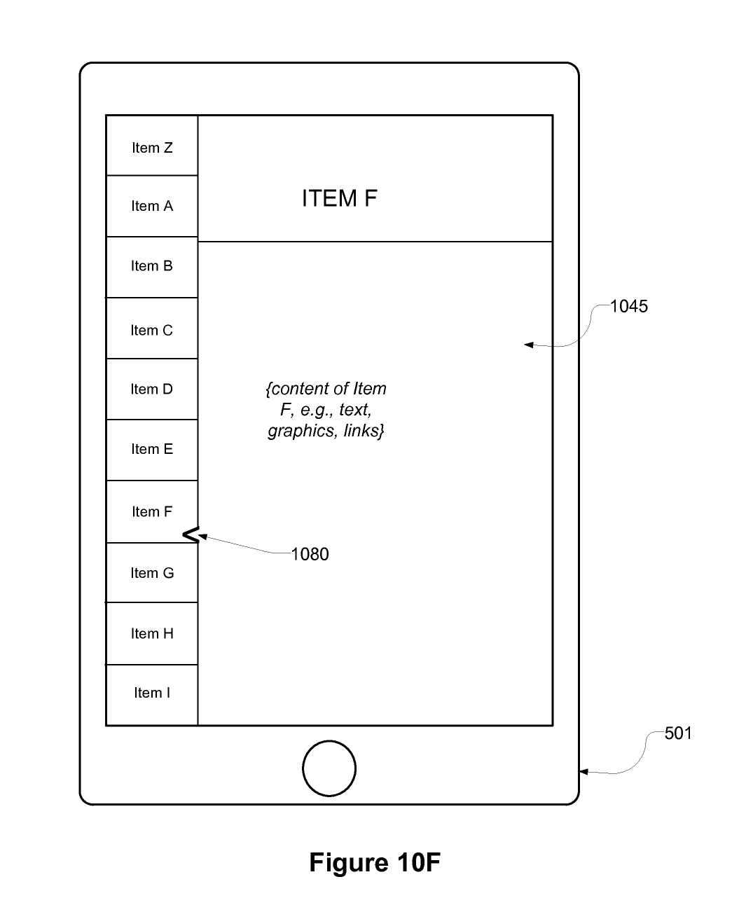

In accordance with some embodiments, in response to detecting a movement of touch input on the content list view, the content item list is synchronously scrolled with the movement of the touch input while maintaining the representation of the first content item at the position of the touch input. FIG. 10A illustrates in schematic form a user interface indicating synchronous scrolling of the content list 1040 with the movement 1015 of the touch input 1010. A midpoint is determined in the content item list 1040. The midpoint is aligned with the position of the touch input. The representation of the first content item 1005 is displayed at the midpoint and is maintained at a position of the first touch input 1010. The scrolling of the content list in the direction of the movement of touch is indicated by the removal of the content Item J from the bottom of the content list, and by the addition of content Item Z at the top of the content list, thus scrolling the list down in this example, as shown by arrow 1008.

In accordance with the response to the movement of the touch input, the content list is synchronously scrolled, as illustrated in FIG. 10B. FIG. 10B illustrates in schematic form a user interface indicating synchronous scrolling of the content list in the direction of the touch input 1025. FIG. 10B illustrates the continuation of scrolling the content list in response to detection of the movement of touch input. The scrolling of the content list 1040 is indicated by the replacement of the Item I from the bottom of the list by Item Y at the top of the list, thus scrolling the list down in this example, as shown by the arrow 1008. The representation of a second content item is at the position of the first touch input and it indicates the currently selected second content item 1005. The currently selected content item 1005 (e.g. Item E) from the content list is displayed in the content item view 1065 adjacent to the content list view.

In some embodiments, the second content item is displayed in response to detecting a completion of a touch input. An example of the completion is a user lifting off the finger from the touch screen display, or releasing the point of contact from the position of the touch input. FIG. 10C illustrates in schematic form a user interface displaying a lift off gesture from the contact point 1055 indicated on the content list view 1040. In response to the lift off gesture, the currently selected content item 1055 (e.g. Item D) from the content list view is displayed in the content item view 1075.

In accordance with some embodiments, in response to detecting a movement of the touch input in the content list view, the representation of the first content item at the position of the touch input is maintained and the content item list is synchronously scrolled with the movement of the touch input. The synchronous scrolling is completed in response to the detection of the completion of the movement of the touch input on the content list view. FIG. 10D-10F illustrate in schematic form a user interface displaying the second content item 1005 (e.g. Item D) in the content list view in a position of the first touch input 1080 on the content list. The content items in the content item list 1040 shift in accordance with the synchronous scroll movement, as described above and indicated by arrow 1008. The representation 1005 of a second content item is maintained at the position of the first touch input 1080 in response to the completion of the synchronous scrolling. The content item (e.g. Item D) currently selected at the position of the first touch input is displayed in the content item view 1075 adjacent to the content list view. In some embodiments the content item view replaces the content item view adjacent to the content list view, as illustrated in FIG. 10E where Item D is shown in its entirety. In some embodiments, the currently selected content item may be indicated by a graphical icon, for example, a chevron 1080, as illustrated in FIG. 10F.

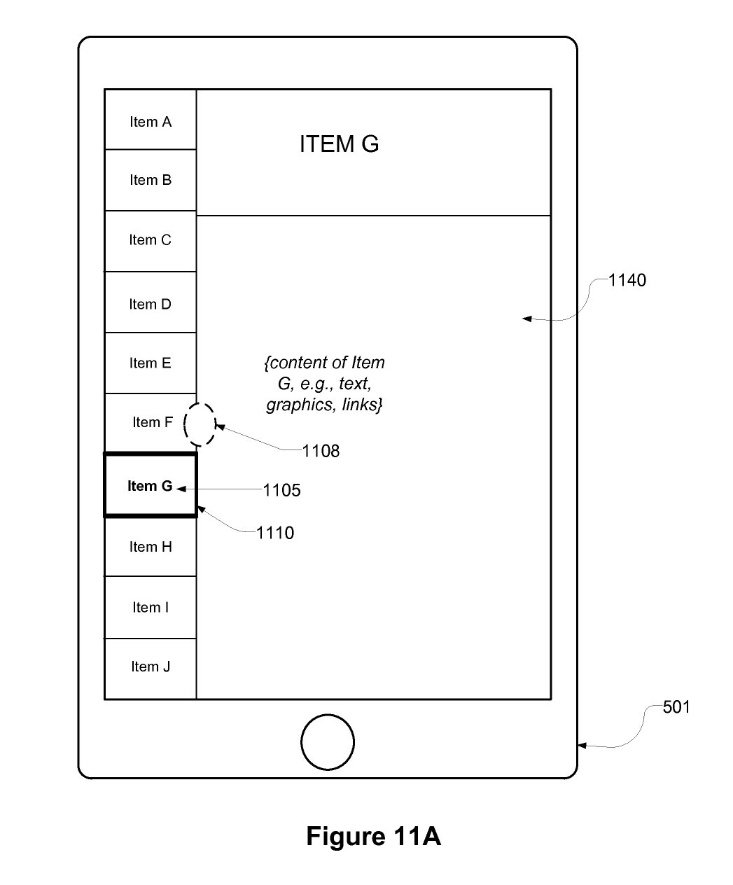

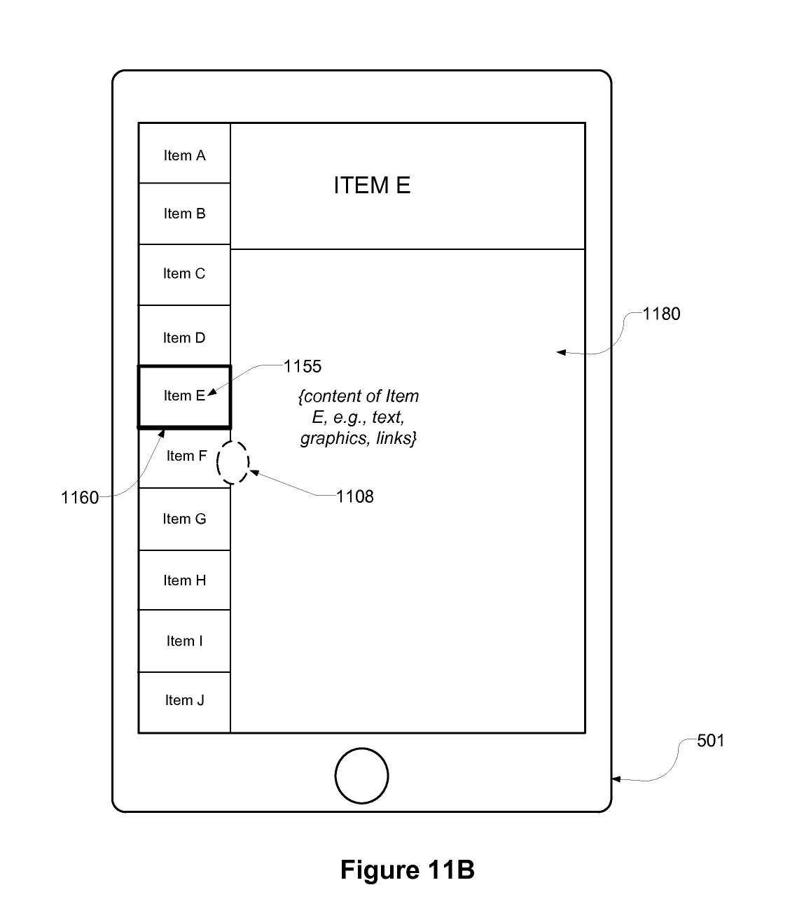

In some embodiments, in response to detecting a touch input on the content list view, a representation of a next or previous content item may be selected. FIG. 11A-11B illustrate in schematic form a user interface displaying a selection of the representation of the 1105 (e.g. Item G, FIG. 11A) or previous 1155 (e.g. Item E, FIG. 11B) content item in the content item list. A current content item (e.g., Item F) is displayed prior to detecting a touch input 1108. On detection of the touch input 1108, a representation of either the next item 1105 (e.g., Item G, FIG. 11A) or the previous item 1155 (e.g., Item E, FIG. 11B) is selected. An indication that the previous or next item is currently selected is displayed by highlighting the content item boundary 1110 (FIG. 11A) or 1160 (FIG. 11B). The content item currently indicated is displayed in the content item view 1140 (content of Item G, FIG. 11A) or 1180 (content of Item E, FIG. 11B) adjacent to the content list view.

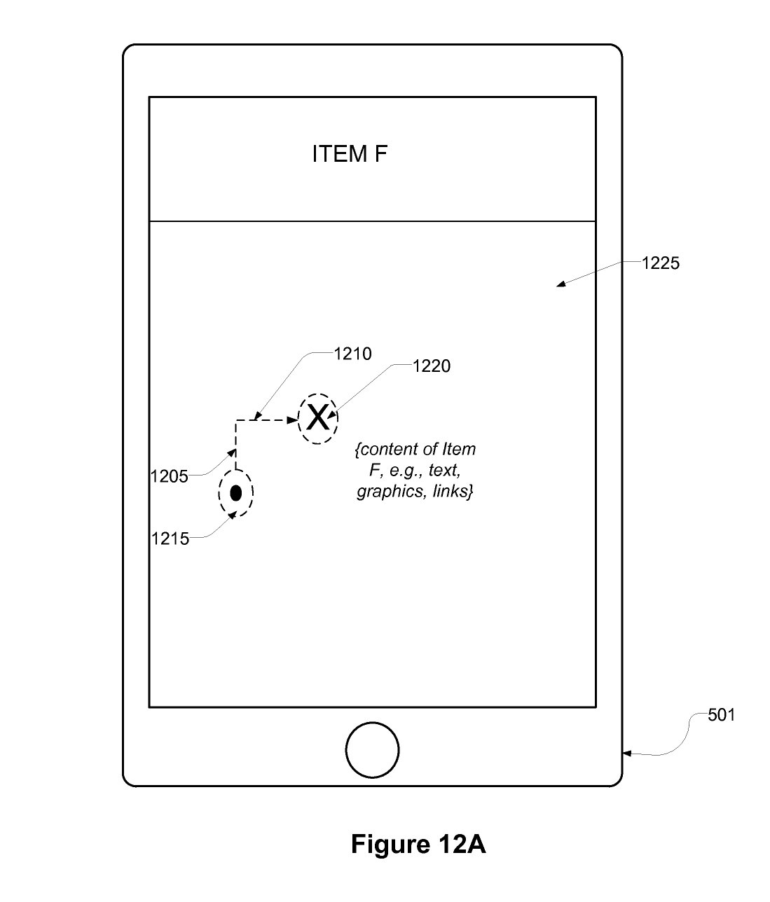

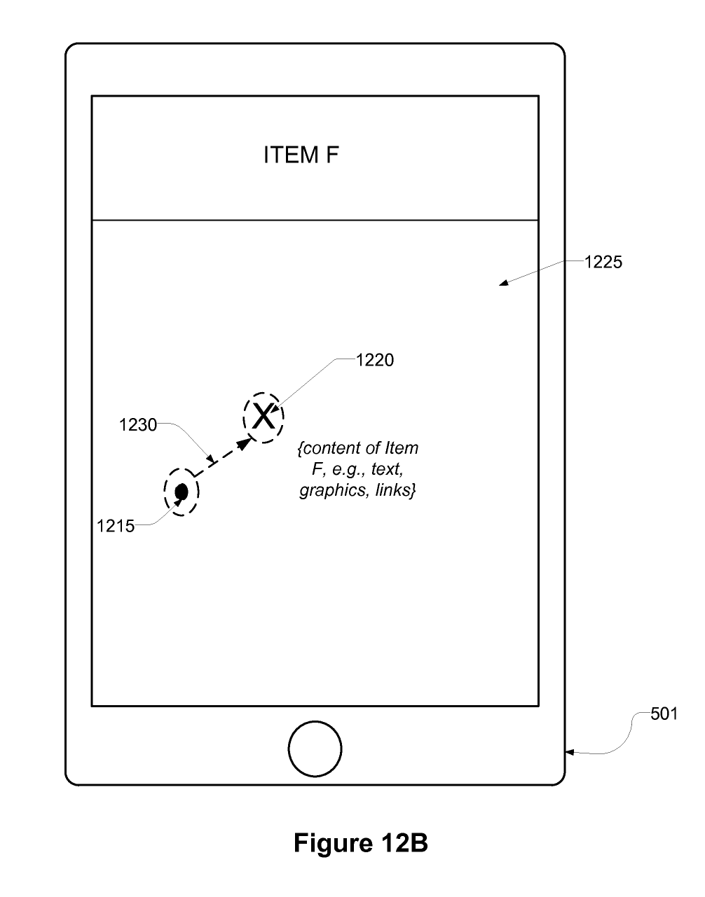

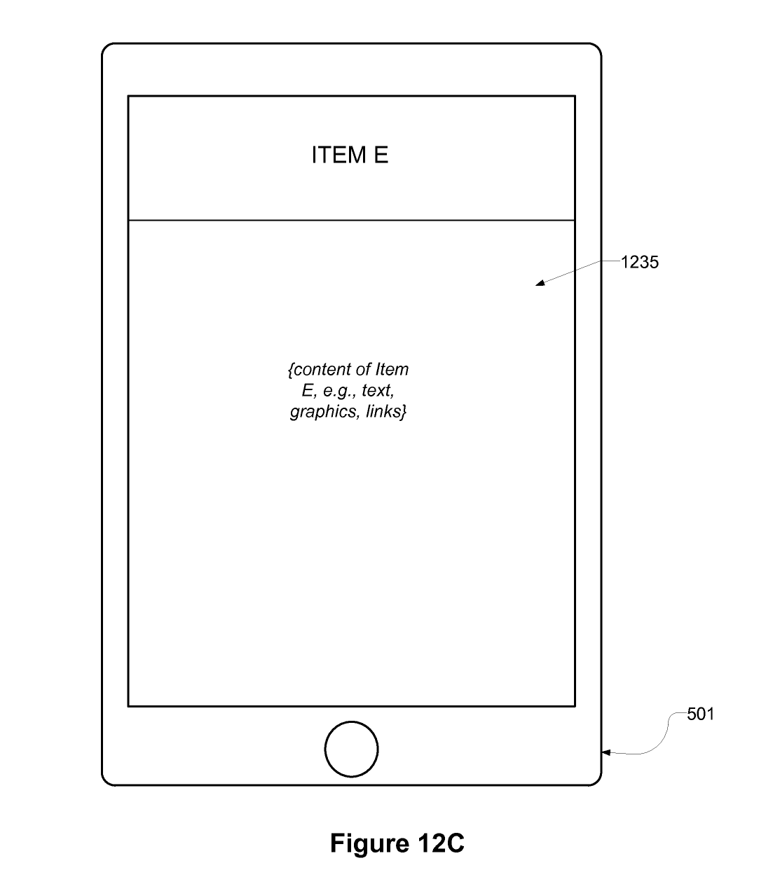

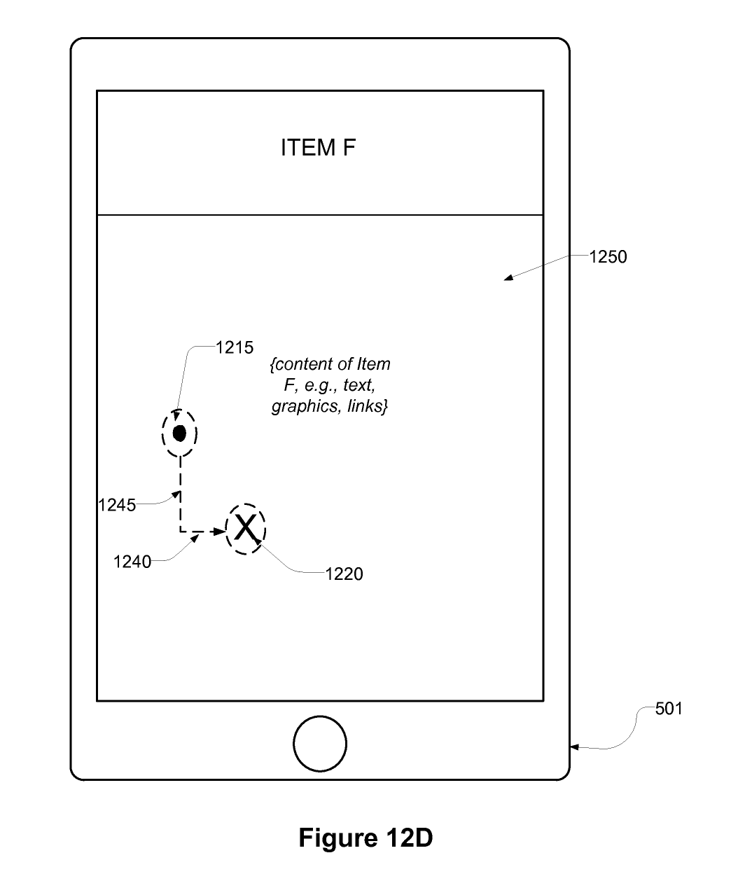

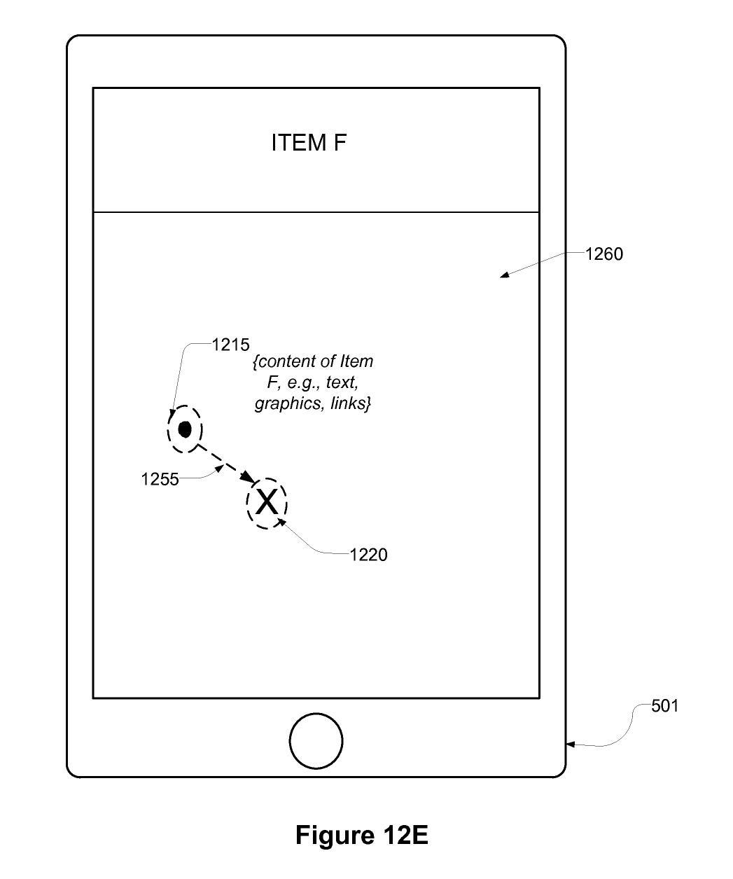

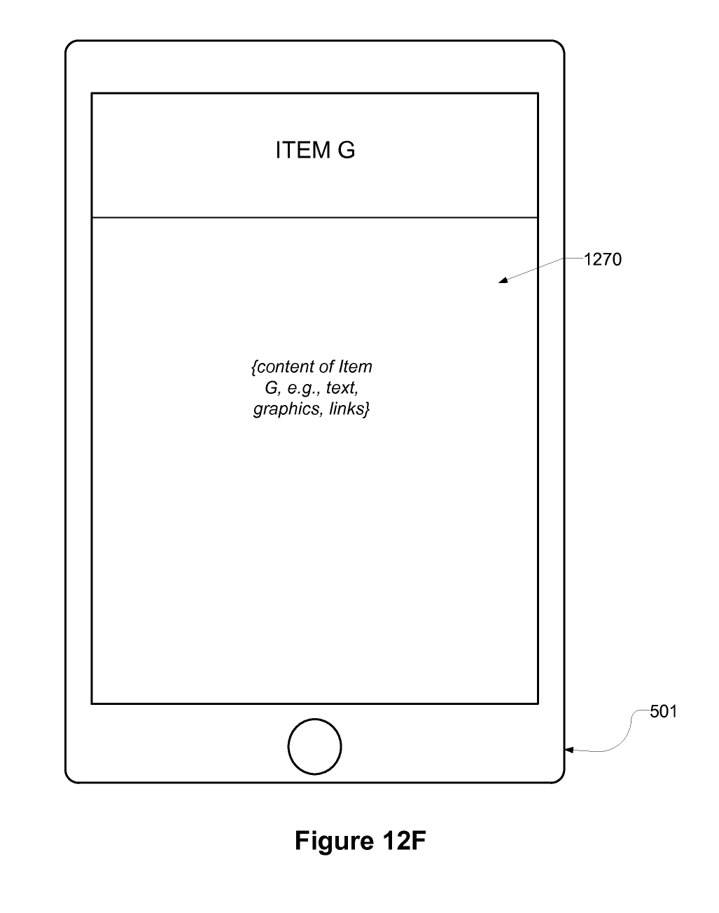

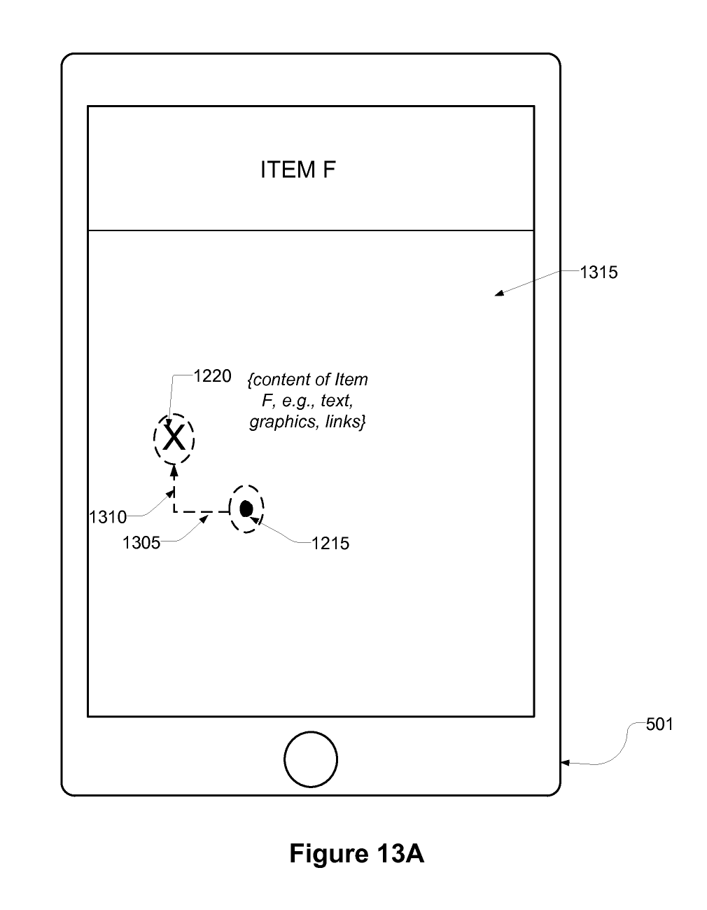

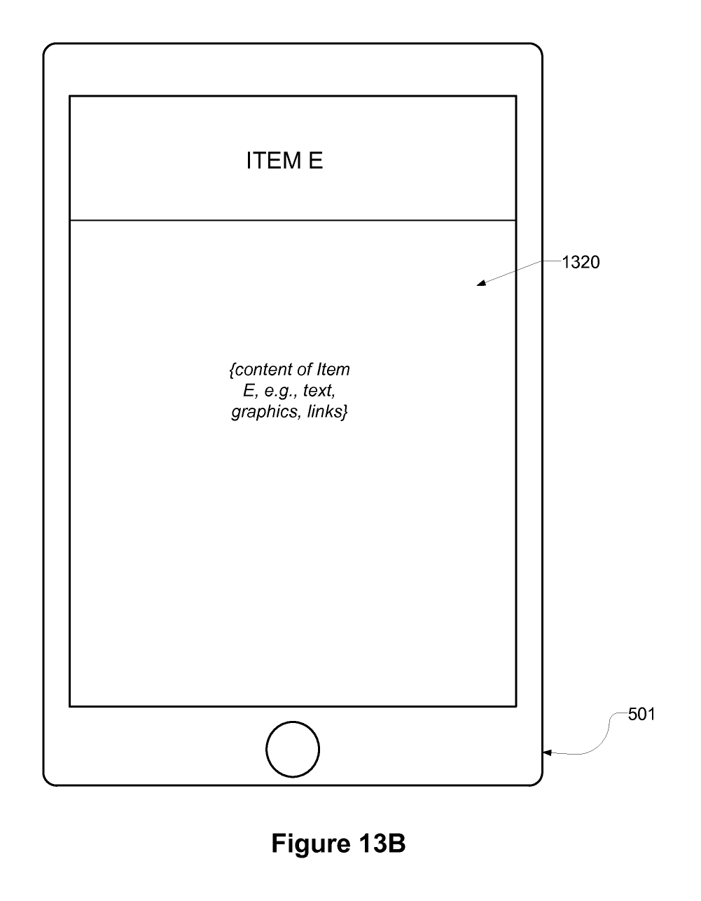

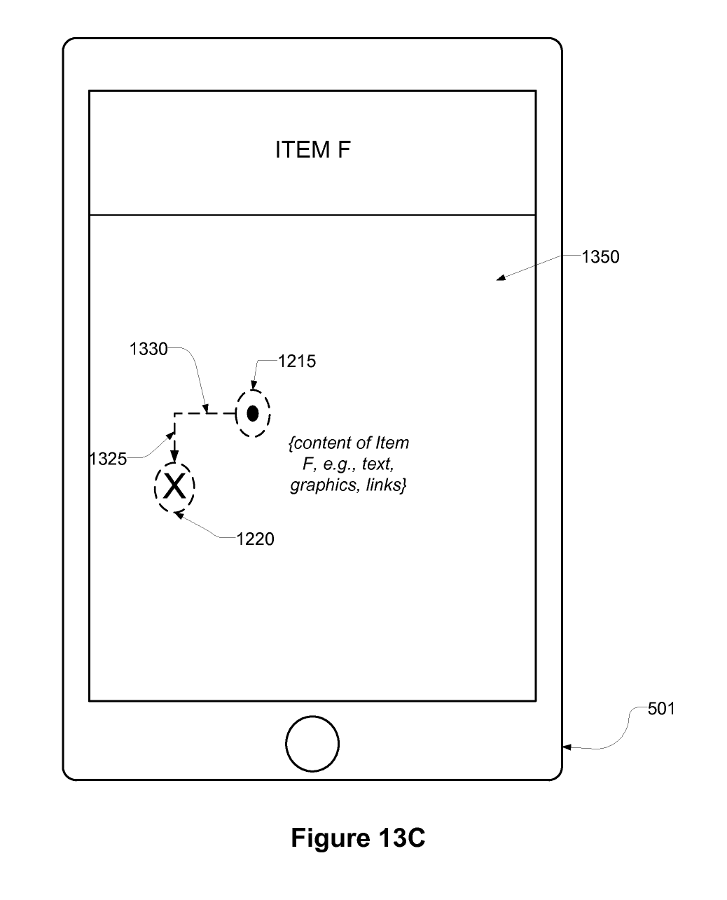

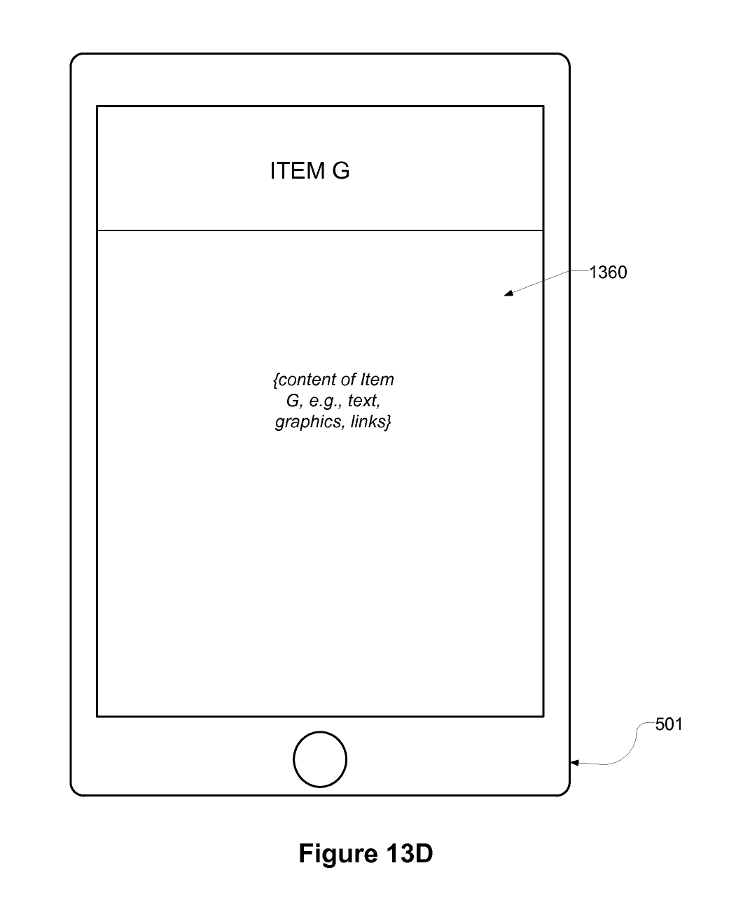

In some embodiments, the content item may be displayed entirely in the content item view. While a first content item is displayed, a first touch input that corresponds to a request to scroll to a second item is detected. In response to detecting the first touch input, it is determined that the input is a continuous gesture consisting essentially of a single vertical movement component followed by a single horizontal movement component, or a single horizontal movement component followed by a single vertical movement component. In accordance with the determination that the touch input comprises a continuous gesture consisting essentially of a single vertical movement component followed by a single horizontal movement component, or a single horizontal movement component followed by a single vertical movement component, the second content item is displayed. FIGS. 12A, 12C, 12D, 12F, and 13A-13D illustrate in schematic form user interfaces of content items entirely in content item view, and continuous gestures consisting essentially of single vertical and horizontal movement components. In response to the continuous gestures such as these examples, the next or previous content items are displayed in the content item view. FIG. 12A illustrates a first content item (e.g. Item F) in a content item view 1225. While it is displayed, a first touch input 1215 starting at a point of contact (indicated by an ellipse with a dot) that could be input anywhere within the content item view 1225 is detected. Further, the continuation of the movement of the touch input reaching an ending point of contact 1220 (indicated by an ellipse with an “X”) located anywhere within the content item view 1225 on the display screen is detected. In these embodiments, the touch input is a continuous gesture consisting essentially of a single vertical movement component 1205 (FIG. 12A) followed by a single horizontal movement component 1210 (FIG. 12A), or a single horizontal movement component 1305 (FIG. 13A) followed by a single vertical movement component 1310 (FIG. 13A). In some embodiments, the direction of the vertical movement component may be upwards with respect to the starting point of contact 1215 as illustrated in FIG. 12A or upwards with respect to the horizontal movement component 1305 as illustrated in FIG. 13A. In some embodiments, the direction of the horizontal movement component may be inwards with respect to the vertical movement component 1205 as illustrated in FIG. 12A or inwards with respect to the starting point of contact 1215 as illustrated in FIG. 13A. The single horizontal and vertical movement components may be approximately 2 cm to 5 cm in length (as measured, for example in pixels). The continuous gestures comprising of at least one of the vertical and horizontal movement components are determined, and in accordance with the determination of the continuous gesture, a previous content item (e.g. Item E) is displayed in the content item view 1235 (FIG. 12C) or 1320 (FIG. 13B).

FIG. 12D illustrates a first content item (e.g. Item F) in a content item view 1250. While it is displayed, a first touch input starting at a point of contact 1215 that could be located anywhere within the content item view 1250, continuing the movement of the touch input to reach an ending point of contact 1220 located anywhere within the content item view 1250 on the display screen is detected. In these embodiments, the touch input is a continuous gesture consisting essentially of a single vertical movement component 1245 (FIG. 12D) followed by a single horizontal movement component 1240 (FIG. 12D) or a single horizontal movement component 1330 (FIG. 13C) followed by a single vertical movement component 1325 (FIG. 13C). In some embodiments, the direction of the vertical movement component may be downwards with respect to the starting point of contact 1215 as illustrated in FIG. 12D or downwards with respect to the horizontal movement component 1330 as illustrated in FIG. 13C. In some embodiments, the direction of the horizontal movement component may be inwards with respect to the vertical movement component 1245 as illustrated in FIG. 12D or outwards with respect to the starting point of contact 1215 as illustrated in FIG. 13C. The single horizontal and vertical movement components may be approximately 2 cm to 5 cm in length. The continuous gestures consisting essentially of at least one of the single vertical and horizontal movement components are determined, and in accordance with the determination of the continuous gesture, a next content item (e.g. Item G) is displayed in the content item view 1270 (FIG. 12F) or 1360 (FIG. 13D).

In some embodiments, the content item may be displayed entirely in the content item view. While a first content item is displayed, a first touch input that corresponds to a request to scroll to a second item is detected. In response to detecting the first touch input, a continuous gesture consisting essentially of a single diagonal movement component is determined. In accordance with the determination that the touch input comprises of a continuous gesture consisting essentially of a single diagonal movement component, the second content item is displayed. FIGS. 12B, 12C, 12E and 12F illustrate in schematic form user interfaces of content items entirely in content item view, and continuous gestures consisting essentially of single diagonal movement components. In response to the continuous gestures, the next or previous content items are displayed in the content item view. FIG. 12B illustrates a first content item (e.g. Item F) in a content item view 1225. While it is displayed, a first touch input 1215 starting at a point of contact (indicated by an ellipse with a dot) that could be input anywhere within the content item view 1225 is detected. Further, the continuation of the movement of the touch input reaching an ending point of contact 1220 (indicated by an ellipse with an “X”) located anywhere within the content item view 1225 on the display screen is detected. The touch input is a continuous gesture consisting essentially of a diagonal movement component 1230 (FIG. 12B) starting at a point of contact 1215 and terminating at an ending point of contact 1220. In some embodiments, the direction of the diagonal movement component may be diagonally upwards with respect to the starting point of contact 1215 as illustrated in FIG. 12B. The diagonal movement component may be angles of approximately 45 degrees (+/−10 degrees) with respect to the starting point of contact 1215 and moving towards the ending point of contact 1220 as illustrated, or at an angle of approximately 135 degrees (+/−10 degrees). The diagonal movement components may be approximately 2 cm to 5 cm in length. The continuous gestures comprising of diagonal movement components are determined, and in accordance with the determination of the continuous gesture, a previous content item (e.g. Item E) is displayed in the content item view 1235 (FIG. 12C).

FIG. 12E illustrates a first content item (e.g. Item F) in a content item view 1225. While it is displayed, a first touch input 1215 starting at a point of contact (indicated by an ellipse with a dot) that could be input anywhere within the content item view 1225 is detected. Further, the continuation of the movement of the touch input reaching an ending point of contact 1220 (indicated by an ellipse with an “X”) located anywhere within the content item view 1225 on the display screen is detected. The touch input is a continuous gesture consisting essentially of a diagonal movement component 1255 (FIG. 12E) starting at a point of contact 1215 and terminating at an ending point of contact 1220. In some embodiments, the direction of the diagonal movement component may be diagonally downwards with respect to the starting point of contact 1215 as illustrated in FIG. 12E. In some embodiments, the direction of the diagonal movement component may be diagonally downwards with respect to the starting point of contact 1215 as illustrated in FIG. 12E. The diagonal movement component may be for example at an angle of approximately 315 degrees (+/−10 degrees) with respect to the starting point of contact 1215 and moving towards the ending point of contact 1220 as illustrated, or at an angle of approximately 225 degrees (+/−10 degrees). The diagonal movement components may be approximately 2 cm to 5 cm in length. The continuous gestures comprising of diagonal movement components are determined, and in accordance with the determination of the continuous gesture, a next content item (e.g. Item G) is displayed in the content item view 1270 (FIG. 12F).

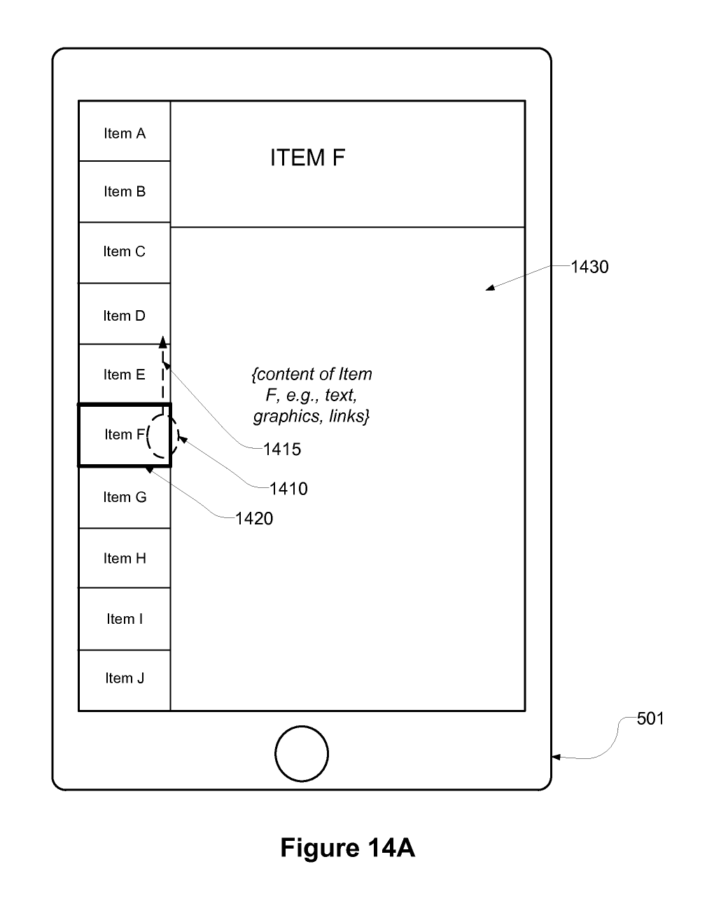

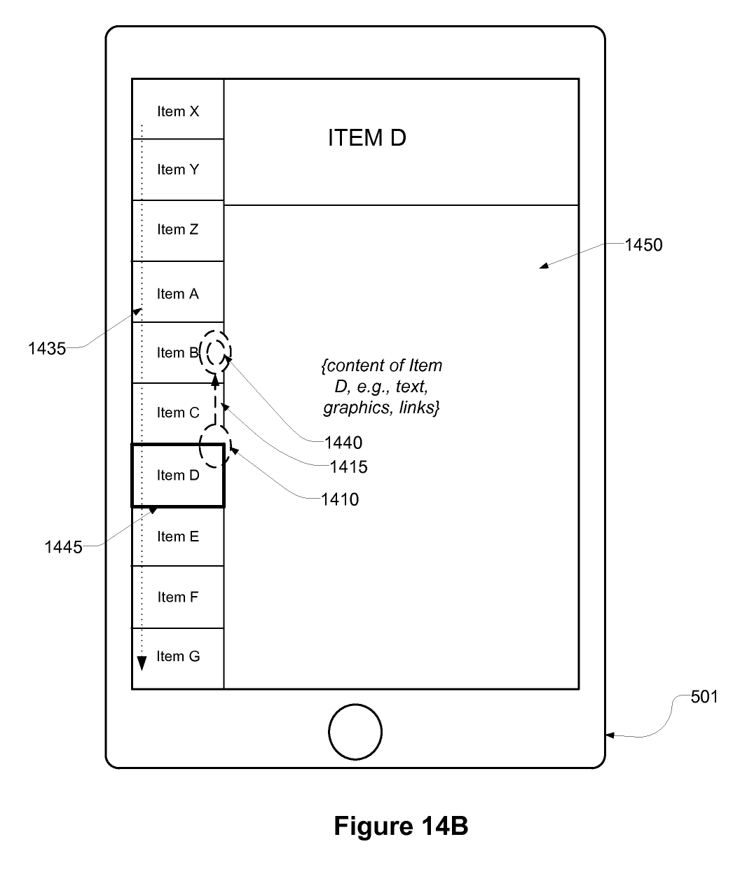

In some embodiments, the content list can be continuously scrolled. This may be useful in case the content list has a long list of content items. FIGS. 14A-14B illustrate in schematic form user interfaces of gestures that invoke continuous scrolling of the content item list. In accordance with some embodiments, as illustrated in FIG. 14A, in response to detecting a movement of touch input 1415 on the content list view, the content item list is synchronously scrolled with the movement of the touch input while maintaining the representation of the first content item (e.g. Item F) at the position of the touch input 1410. A midpoint is determined in the content item list 1410. The midpoint is aligned with the position of the touch input. The representation of the first content item 1420 is displayed at the midpoint and is maintained at a position of the first touch input 1410. The movement of touch is paused for a predetermined time at a point of contact 1440 indicated by two concentric ellipses (FIG. 14B) in the direction of the movement of touch 1415, invoking a continuous scroll of the content list. The scrolling of the content list in the direction opposite to the movement of touch 1415 is indicated by the removal of the content Items H, I and J from the bottom of the content list, and by the addition of content Items X, Y and Z at the top of the content list, thus scrolling the list down in FIG. 14B, as shown by arrow 1435. The representation of the second content item (e.g. Item D) is displayed in the content item list and is maintained at a position of the first touch input 1410. The second content item (e.g. Item D) is displayed in the content item view 1450.

FIG. 15 illustrates a method 1500 for displaying a content item in a content view and displaying a content list view in response to the touch input 528 (e.g. FIG. 5A-5F) in accordance with some embodiments. In some embodiments, a first content item 505 is displayed 1505 in a content item view 502 for (e.g. FIG. 5A displays a content item from an email application in an email content view). While the first content item 505 is displayed, a first touch input 528 is detected 1510 that corresponds to a request to display a content list view 544 (FIG. 5C), 545 (FIG. 5D). The first touch input 528, for example, may be a navigation gesture, that starts at a first location for example, proximate to one edge of the screen display and moves in a vertical or horizontal direction towards a second location, for example the opposing edge of the screen display. In this example, the navigation gesture is a single horizontal navigation gesture moving from the left edge towards the right edge or vice versa. The gesture need not reach the opposing edge. Responsive 1515 to detecting the first touch input 528, the display of the content view 502 is shifted 1520. The display of the content view is shifted in the direction of the first touch input 528, as illustrated in FIG. 5B. In continuation of the response, a content list view is displayed 1525. adjacent to the content item view; the content list view includes a representation of the first content item 530 and representations of the previous content items and the next content items in the content item view A representation is a short description, icon, thumbnail image, or other presentation of the content item that conveys identifying information for the content item without displaying the entire data of the content item. The first content item 548 is separated from the second content item 531 by a representation of a boundary 532 between them. An indication that the representation of a content item from the content item list is currently selected 1530 is displayed. The indication may be for example, highlighting the boundary of the currently selected content item in the content item list, or by other graphical indicia, for example by shading, color, texture, or text formatting, or other characteristics. In some embodiments, the content list view may be displayed partially or entirely on the display screen. In case the content list view is displayed entirely on the screen, the content item view is removed from display.

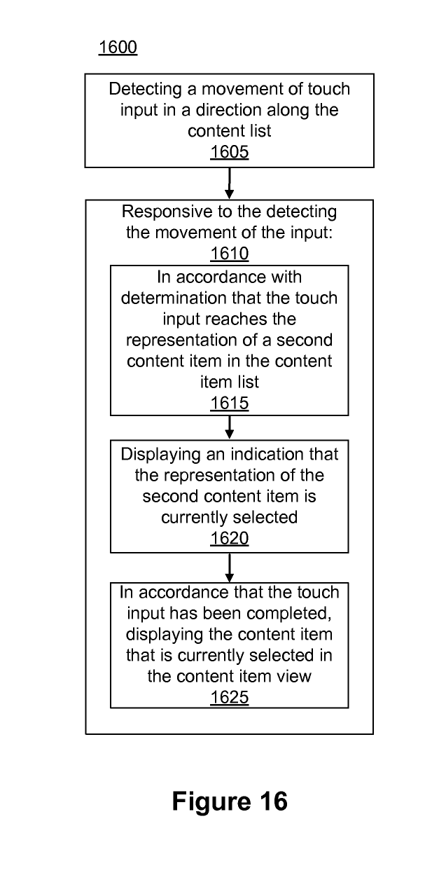

FIG. 16 illustrates a method of selecting 1600 a second content item in the content list and displaying the second content item in the content item view, for example as illustrated in FIGS. 9A-11B. While the content list is displayed, a movement of touch input 908 in a direction along the content list is detected 1605. The touch input is initiated at a first position 905, an initial contact point and the movement of the touch input 908 pausing for a predetermined amount of time in a second position is detected. An offset of the second position is determined with respect to the first position 905 of the touch input. The direction of the movement of touch input 908 could be upwards or downwards along the list. In some embodiments, the offset is the number of content items above or below an initial content item representation in the content list. Responsive to the detection 1610 of the movement of the touch input 908, it is determined 1615 that the touch input 905 reaches the representation of a second content item 915 in the content item list. An indication 1620 that the representation 910 of the second item is currently selected is displayed. The indication may be for example, highlighting the boundary of the second content item, or by other graphical indicia like color, shading, texture, text formatting, or other characteristics. In some embodiments, the movement of the touch input may be completed 1055 by a lifting the finger off or breaking contact with the touch screen display. In accordance that the touch input has been completed the second content item 1005 is displayed 1625 in the content item view 1075.

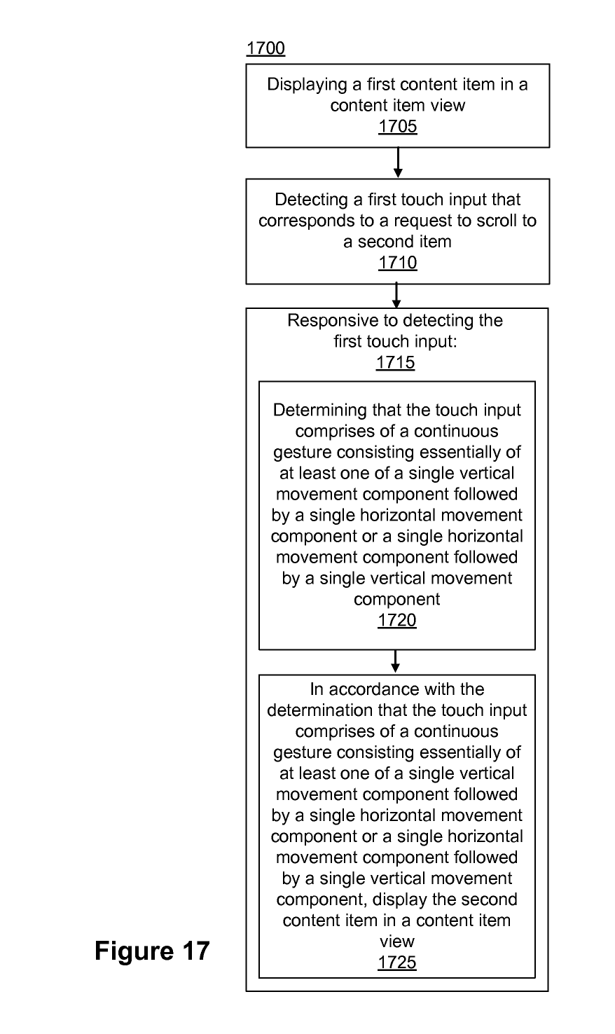

FIG. 17 illustrates a method for displaying 1700 previous or next content items in response to a movement of the touch input comprising of a continuous gesture consisting essentially of single vertical 1205 and horizontal movement 1210 components in a content item view 1225 in accordance with some embodiments. A first content item (e.g. ITEM F in FIG. 12A) is displayed 1705 in a content item view 1225. While the first content item is displayed, a first touch input is detected 1710 that corresponds to a request to scroll to a second item. In some embodiments, the first touch input is a continuous gesture starting at an initial point of contact 1215 located anywhere on the display of the content item view 1225. The movement of touch continues from the initial point of contact 1215 to reach an ending point of contact 1220 that is located anywhere on the display of the content item view 1225. Responsive 1715 to detecting the first touch input, it is determined 1720 that the touch input comprises of a continuous gesture consisting essentially of at least one of a single vertical movement component 1205 followed by a single horizontal movement component 1210 or a single horizontal movement component 1305 followed by a single vertical movement component 1310. In some embodiments, the direction of the vertical movement component 1310, 1205 may be upwards or downwards with respect to the starting point of contact 1215 or the horizontal movement component 1305. In some embodiments, the direction of the horizontal movement component 1330, 1210 may be outwards or inwards with respect to the starting point of contact 1215 or the vertical movement component 1205. In accordance with the determination that the touch input comprises of a continuous gesture consisting essentially at least one of a single vertical movement component 1205 followed by a single horizontal movement 1210 or a single horizontal movement component 1305 followed by a single vertical movement component 1310, the second content item (e.g. Item E, FIG. 12C) is displayed 1725 in the content item view 1235.

In some embodiments, the continuous gesture may move vertically upwards from an initial contact point 1215 and horizontally outwards from the vertical movement component 1205 as illustrated in FIG. 12A. In some embodiments the continuous gesture may move horizontally inwards from an initial contact point 1215 and vertically upwards from the horizontal movement component 1305 as illustrated in FIG. 13A. In accordance with the determination that the touch input consists essentially of a continuous gesture that moves up and out or in and up from the starting point, the previous content item (e.g. Item E, FIG. 12C) is displayed in the content item view 1235.

In some embodiments, the continuous gesture may move vertically downwards from an initial contact point 1215 and horizontally outwards from the vertical movement component 1245 as illustrated in FIG. 12D In some embodiments the continuous gesture may move horizontally inwards from an initial contact point 1215 and vertically downwards from the horizontal movement component 1325 as illustrated in FIG. 13C. In accordance with the determination that the touch input consists essentially of a continuous gesture that moves down and out or in and down from the starting point, the next content item (e.g. Item G, FIG. 12F) is displayed in the content item view.

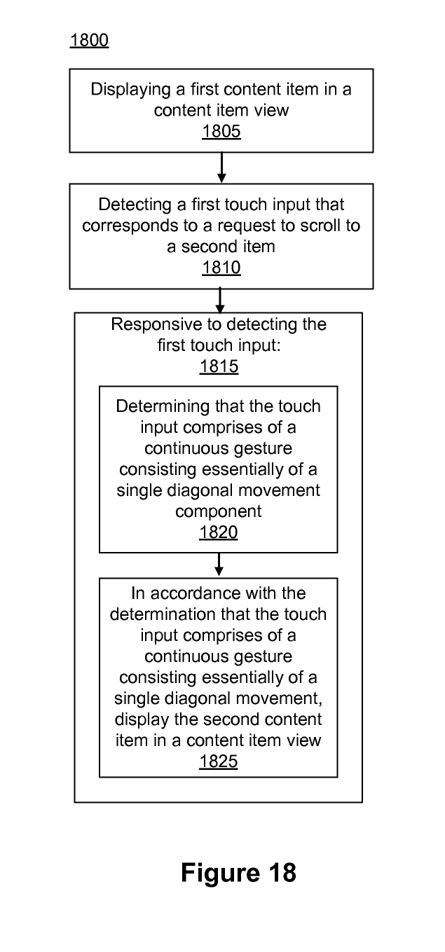

FIG. 18 illustrates a method for displaying 1800 previous or next content items in response to a movement of the touch input comprising of a continuous gesture consisting essentially of single diagonal movement components (e.g. 1230, FIG. 12B) in a content item view 1225 in accordance with some embodiments. A first content item (e.g. Item F, FIG. 12A) is displayed 1805 in content item view 1225. While the first content item is displayed, a first touch input is detected that corresponds to a request 1810 to scroll to a second item. In some embodiments, the first touch input is a continuous gesture starting at an initial point of contact (e.g. 1215, FIG. 12B) located anywhere on the display of the content item view (e.g. 1225, FIG. 12B). The movement of touch continues from the initial point of contact to reach an ending point of contact (e.g. 1220, FIG. 12B) that is located anywhere on the display of the content item view. Responsive to detecting 1815 the first touch input, it is determined 1820 that the touch input comprises of a continuous gesture consisting essentially of a single diagonal movement component 1230. In some embodiments, the direction of the single diagonal movement component could be diagonally upwards or downwards from the starting point of contact 1215 moving at an angle towards the ending point of contact. In accordance with the determination 1725 that the touch input comprises of a continuous gesture consisting essentially of a single diagonal movement component (e.g. 1230, FIG. 12B), the second content item (e.g. Item E, FIG. 12C) is displayed in the content item view 1225

In some embodiments, the continuous gesture may move diagonally upwards at an angle of approximately 45 degrees (+/−10 degrees) from the starting point of contact 1215 towards the ending point of contact 1220 as illustrated in FIG. 12B. In accordance with the determination that the touch input consists essentially of a continuous gesture that moves diagonally up from the starting point, the previous content item (e.g. Item E, FIG. 12C) is displayed in the content item view 1225.

In some embodiments, the continuous gesture may progress diagonally downwards at an angle of approximately 315 degrees (+/−10 degrees) from the starting point of contact 1215 towards the ending point of contact 1220 as illustrated in FIG. 12E. In accordance with the determination that the touch input consists essentially of a continuous gesture that moves diagonally downwards 1255 from the starting point, the next content item (e.g. Item G, FIG. 12F) is displayed in the content item view.

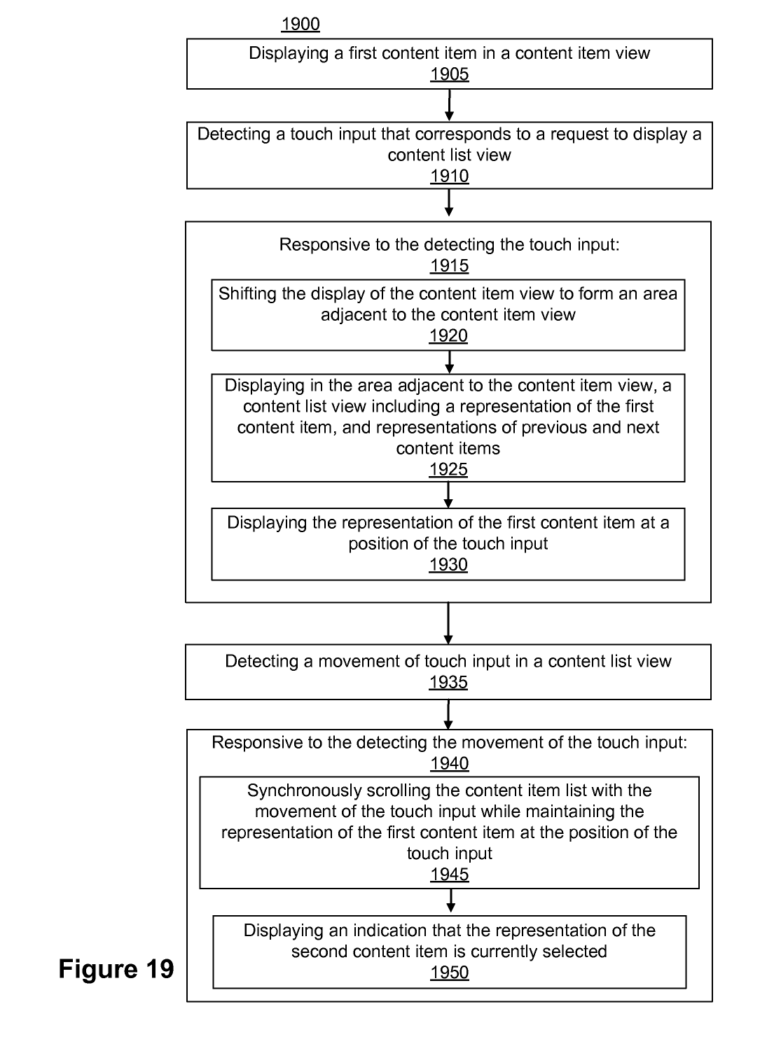

FIG. 19 illustrates a method of scrolling 1900 a content list to display a second content item (e.g. Item E, FIG. 10B) from a content list while maintaining the position 1010 of the representation of a first content item (e.g. Item F, FIG. 10A) in the content item list (e.g. 1040, FIG. 10A) in accordance with some embodiments. In some embodiments the first content item is displayed 1905 in a content item view (e.g. 1045, FIG. 10A). A touch input is detected 1910 that corresponds to a request to display a content list view. Responsive 1915 to the detection of the touch input, the display of the content item view is shifted 1920 in the direction of the movement of the touch to form an area adjacent to the content item view. A content list view (e.g. 1040, FIG. 10A) is displayed in this area, the content list includes a representation of a first content item (e.g. Item F, FIG. 10A) and representations of the previous and the next content items (e.g. Item Z to Item I, FIG. 10A). A representation of the first content item is displayed 1930 at a position of the touch input 1010.

A movement of the touch input is detected 1935 on the content item list. In some embodiments, the movement of the touch input (e.g. 1015, FIG. 10A) may be a single vertical navigation gesture, moving in a vertical direction from a starting location for example, the top edge to a second location for example, the bottom edge or vice versa of the screen display. In accordance with some embodiments, in response 1940 to detecting a movement of touch input 1015 on the content list view 1045, a midpoint (e.g. 1010, FIG. 10A) is determined in the content item list. The midpoint is aligned with the position of the touch input, for example, the ellipse on Item F illustrated in FIG. 10A. The representation of the first content item, Item F in FIG. 10A is displayed at the midpoint and is maintained at a position of the first touch input. The scrolling of the content list in the direction of the movement of touch, for example in FIG. 10 A, the touch input is shown to move downwards indicated by arrow 1015 and the content item list scrolls in the same direction indicated by the arrow 1008. Alternatively, the scrolling of the list is indicated by the removal of the content Item J from the bottom of the content list, and by the addition of content Item Z at the top of the content list, thus scrolling the list down in the example shown in FIG. 10 A. The content item list is synchronously scrolled 1945 with the movement of the touch input while maintaining the representation of the first content item at the position of the touch input.

The representation of a second content item (e.g. Item E, FIG. 10B) is displayed at the position 1010 of the first touch input. The indication that the representation of a second content item is selected is displayed 1950, by highlighting the boundary or any other graphical indicia (e.g. 1080, FIG. 10F). The second content item (e.g. Item E, FIG. 10B) from the content list 1040 is displayed in the content item view (e.g. 1065, FIG. 10B) adjacent to the content list view during the movement of touch or in response to the completion (e.g. 1055, FIG. 10C) of the touch movement. An example of the completion of touch movement is the user lifting off the finger from the display screen, i.e. finger up or break contact with the touch screen display.

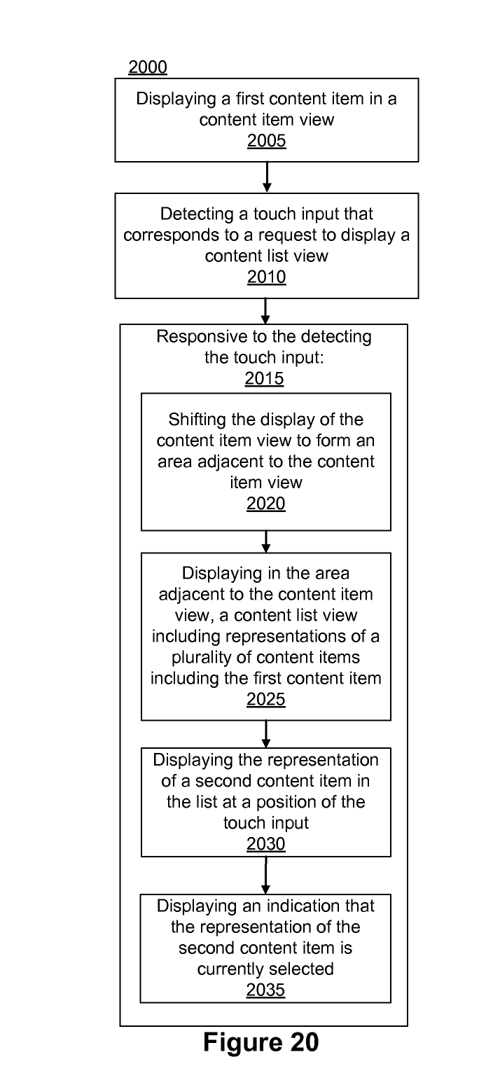

FIG. 20 illustrates a method for displaying 2000 an indication that a representation of a second content item is selected in response to a touch input at a position of the touch input in accordance with some embodiments. In some embodiments, a first content item (e.g. 505, FIG. 5A) is displayed 2005 in a content item view (e.g. 502, FIG. 5A). A touch input (e.g. 525, FIG. 5B) corresponding to a request to display 2010 a content list view (e.g. 544, FIG. 5C) is detected. Responsive 2015 to detecting the touch input the display of the content item view is shifted 2020 to form an area adjacent to it. A content list (e.g. 545, FIG. 5E) is displayed 2025 in the area adjacent to the content item view (e.g. 555, FIG. 5E) and the content list includes a plurality of representations of content items (Item A-Item J, FIG. 5E) including a representation of the first content item (e.g. Item F, FIG. 5E).

The representation of a second content item (e.g. Item G, FIG. 5E) in the content list 545 is displayed 2030 at the position of the touch input 525. For example, in FIG. 5E, a previous content item, Item E or next content item, Item G may be automatically selected and displayed at the position of the touch input 525. An indication that the representation of the second content item is currently selected is displayed 2035. The indication may be for example, highlighting the boundary of the second content item in the content list (e.g. 910, FIG. 9A), or by other graphical indicia, for example by shading, color, texture, or text formatting, or other characteristics.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method, comprising:
displaying a first content in a content item view;
while the first content item is displayed, detecting a first touch input that corresponds to a request to display a content list view;
responsive to detecting the first touch input:
shifting the display of the content item view;
displaying adjacent to the content item view, a content list view including a representation of the first content item that reaches the representation of a second content item in the content item list, the content list including representations of one or more previous content items and one or more next content items in the content item list;
while the content list view is displayed, detecting a movement of the touch input along the content list;
responsive to detecting the movement of the touch input:
displaying an indication that the representation of the second content item is currently selected.

2. The computer-implemented method of claim 1, wherein detecting a first touch input that corresponds to a request to display a content list view, further comprises:
detecting a navigation gesture starting from a first contact point on a screen display and moving with a substantially linear, continuous, uninterrupted manner, towards a second contact point on the screen display.

3. The computer-implemented method of claim 1, further comprising:
displaying the content item view along the first edge of the screen display.

4. The computer-implemented method of claim 1, wherein the content item view comprises a first portion and a second portion, and wherein shifting the display of the content item view, further comprises:
sliding the first portion of the content item view off the screen; and
displaying the second portion of the content item view on the screen display.

5. The computer-implemented method of claim 1, wherein shifting the display of the content item view, further comprises:
sliding the content item view to a predetermined position on the screen display.

6. The computer-implemented method of claim 1, wherein shifting the display of the content item view further comprises:
moving the display of the content item view synchronously with the first touch input.

7. The computer-implemented method of claim 1, wherein shifting the display of the content item view further comprises:
shifting the display of the content item view at a rate/velocity that is greater than a rate/velocity of the first touch input.

8. The computer-implemented method of claim 1, wherein shifting the display of the content item view further comprises:
detecting a first amount of movement of the touch input in a first direction;
shifting the content item view by an amount determined based on the first amount of movement of the touch input in the first direction;
detecting a second amount of movement of the touch input in the first direction; and
shifting the content item view a multiple of the second amount of movement of the touch input in the first direction.

9. The computer-implemented method of claim 1 wherein displaying adjacent to the content item view, a content list view, further comprises:
displaying an indication that the representation of the first content item is currently selected.

10. The computer-implemented method of claim 1, wherein displaying an indication that the representation of the first content item is currently selected, further comprises:
changing an appearance of the representation of the second content item in the content list view.

11. The computer-implemented method of claim 1, wherein displaying an indication that the representation of the first content item is currently selected, further comprises:
concurrently displaying at least a portion of the content list view and at least a portion of the content item view.

12. The computer-implemented method of claim 1, wherein displaying the second content item in the content item view, further comprises:
displaying the second content item in the content item view in response to detecting a completion of the touch input.

13. The computer-implemented method of claim 1, wherein displaying an indication that the representation of the second content item is currently selected further comprises:
displaying the second content item in the content item view.

14. The computer-implemented method of claim 1, wherein the content item view comprises a first portion and a second portion, wherein shifting the display of the content item view, further comprises:
sliding the first portion of the content item view off the screen; and
displaying the second portion of the content item view on the screen display;
and wherein displaying the second content item in the content item view further comprises:
displaying a portion of the second content item in the second portion of the content item view, while a remaining portion of the second content item is partially off the screen display.

15. The computer-implemented method of claim 1, wherein displaying the second content item in the content item view, further comprises:
displaying the second content item in the content item view during the movement of the touch input.

16. The computer-implemented method of claim 1, wherein the touch input is initiated at a first position, further comprising:
detecting that the movement of the touch input has paused for a predetermined amount of time on a second position in the content list view;
determining an offset of the second position with respect to the first position; and
responsive to the offset of the second position, scrolling the content item list.

17. The computer-implemented method of claim 1 wherein the offset is the number of content items above or below an initial content item representation in the content item list view.

18. The computer-implemented method of claim 1, wherein, in accordance with a determination that the touch input reaches the representation of a second content item in the content item list, displaying an indication that the representation of the second content item is currently selected, further comprises:
displaying a boundary between the representation of the first content item and the representation of second content item in the content item list view;
detecting that the touch input has reached the boundary between the representation of the first content item and the representation of second content item; and
responsive to the detecting, displaying the indication that the representation of the second content item is currently selected.

19.-26. (canceled)

27. A computer-implemented method, comprising:
displaying a first content in a content item view;
while the first content item is displayed, detecting a touch input that corresponds to a request to display a content list view;
responsive to detecting the touch input:
shifting the display of the content item view;
displaying adjacent to the content item view, a content list view including representations of a plurality of content items, including the first content item;
displaying the representation of a second content item in the list, different from the first content item, at a position of the touch input;
displaying an indication that the representation of the second content item is currently selected.

28. The computer-implemented method of claim 27, further comprising:
while that indication that the representation of the second content item is currently selected, detecting a completion of the touch input; and
responsive to the completion of the touch input, removing the content list view, and displaying the second content item in the content view.

29. The computer-implemented method of claim 27, wherein the representation of the second content item is immediately prior to the representation of the first content item in the content list view.

30. The computer-implemented method of claim 27, wherein the representation of the second content item is immediately after the representation of the first content item in the content list view.

31. A computer-program product comprising a non-transitory computer readable storage medium storing executable code, the code when executed causes a processor to perform steps to:
display a first content in a content item view;
while the first content item is displayed, detect a first touch input that corresponds to a request to display a content list view;
responsive to detecting the first touch input:
shift the display of the content item view;
display adjacent to the content item view, a content list view including a representation of the first content item that reaches the representation of a second content item in the content item list, the content list including representations of one or more previous content items and one or more next content items in the content item list;
while the content list view is displayed, detect a movement of the touch input along the content list;
responsive to detecting the movement of the touch input:
display an indication that the representation of the second content item is currently selected.

32-33. (canceled)

34. An electronic device, comprising:
a display unit configured to display a first content in a content item view;
a touch-sensitive surface unit configured to receive user contacts; and
a processing unit coupled to the display unit and the touch-sensitive surface unit, the processing unit configured to:
while the first content item is displayed, detecting a first touch input that corresponds to a request to display a content list view;
responsive to detecting the first touch input:
shifting the display of the content item view;
displaying adjacent to the content item view, a content list view including a representation of the first content item that reaches the representation of a second content item in the content item list, the content list including representations of one or more previous content items and one or more next content items in the content item list; while the content list view is displayed, detecting a movement of the touch input along the content list;
responsive to detecting the movement of the touch input:
displaying an indication that the representation of the second content item is currently selected.

35.-63. (canceled)
